(19) United States
(12) Patent Application Publication
(10) Pub. No.: US 2010/0257963 A1
(43) Pub. Date: Oct. 14, 2010

(54) DOUBLE CLUTCH TRANSMISSION

(75) Inventors: Wolfgang RIEGER, Friedrichshafen (DE); Matthias REISCH, Ravensburg (DE); Juergen WAFZIG, Eriskirch (DE); Philip RECKER, Friedrichshafen (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,978

(22) Filed: Apr. 13, 2010

(30) Foreign Application Priority Data
Apr. 14, 2009 (DE) 10 2009 002 353.4

(51) Int. Cl. F16H 3/20

(52) U.S. Cl. 74/331

(57) ABSTRACT

A double clutch transmission with two clutches (K1, K2) which each have input sides connected with an input shaft (w_an) and output sides respectively connected with one of two coaxially arranged transmission input shafts (w_k1, w_k2). At least two countershafts (w_v1, w_v2) are provided on which are mounted idler gearwheels (8, 9, 10, 11, 12, 13, 14, 15) while, on the two transmission input shafts (w_k1, w_k2), are mounted fixed gearwheels (1, 2, 3, 4, 5). At least several power-shiftable forward gears (1, 2, 3, 4, 5, 6, 7, 8) and at least one reverse gear (R1, R2, R3) are shiftable by the transmission. Five gear planes (8-12, 9-2, 3-13, 10-14, 11-15) are provided so that at least one power-shiftable winding path gear (G1, O1) can be shifted via at least one shift element (M).

This application claims priority from German patent application serial no. 10 2009 002 353.4 filed Apr. 14, 2009.

### FIELD OF THE INVENTION

The present invention relates to a double clutch transmission system.

### BACKGROUND OF THE INVENTION

A six- or seven-speed transmission is known from printed publication DE 103 05 241 A1. The double clutch transmission comprises two clutches, each connected with its input side to the input shaft and with its output side to one of the two transmission input shafts respectively. The two transmission input shafts are arranged coaxially to one another. Moreover, two countershafts are arranged axially parallel to the two transmission input shafts, the idler gears of which mesh with fixed gears of the transmission input shafts. Moreover, axially displaceable coupling devices are connected in a rotationally fixed manner to the countershafts, in order to shift the respective toothed gear wheels. The respectively selected ratio will be transmitted via the output gears to a differential gear. In order to obtain the desired transmission ratio step in the double clutch transmission of the prior art, a multitude of gear planes is necessary, so that a significant construction space is needed for the installation.

Moreover, a spur-gear multi-speed transmission is known from printed publication DE 38 22 330 A1. The spur-gear multi-speed transmission comprises a double clutch transmission shiftable under load, one part of which is connected with an input shaft and another part with a rotatable input hollow shaft placed on the input shaft. For certain ratios, the input shaft can be coupled via a shift element with the input hollow shaft.

A powershift transmission is known from publication DE 10 2004 001 961 A1 having two clutches that are allocated each to a subtransmission. The transmission input shafts of the two subtransmissions are arranged coaxially to one another and mesh via fixed gears with idler gears of the allocated shaft elements. The respective idler gears of the countershaft can be connected in a rotationally fixed manner with the respective countershaft through allocated shift elements. An eight-speed transmission is known from this publication having another shift element to couple the two transmission input shafts in order to obtain another transmission ratio step. In this embodiment, already the seven-speed transmission requires at least six gear planes in the subtransmissions in order to obtain the transmission ratio steps. This creates an undesirable extension of the construction length in axial direction, thus, considerably limiting the installation possibility in a vehicle.

Moreover, another powershift transmission is known from publication DE 10 2005 028 532 A1 comprising two input shafts and only one countershaft. For example, an eight-speed transmission requires in this embodiment more than seven gear planes, in order to obtain the transmission ratio steps, in particular the reverse ratios. This creates an undesirable extension of the installation length in axial direction.

### SUMMARY OF THE INVENTION

The object of the present invention is to recommend a double clutch transmission of the type mentioned above, whereby several power shiftable transmission ratio steps can be realized as reasonable as possible and with as few components parts as possible and with low construction space.

In accordance therewith, a construction space-optimized double clutch transmission with two clutches is recommended, the input sides of which are connected with an input shaft and the output sides of which are connected respectively with one of two transmission input shafts coaxially arranged to one another. The double clutch transmission comprises at least two countershafts or similar, on which gears embodied as idler gears are rotably arranged, while on both input shafts, rotationally fixed gear wheels, embodied as fixed gears, are provided, which are engaged at least in part with the idler gears. Moreover, several coupling devices are provided for a rotationally fixed connection of an idler gear with a countershaft. The double clutch transmission of the invention has on each of the countershafts an output gear or constant pinion gear respectively, which are each coupled with gearing of an input shaft, in order to connect the respective countershaft with the output and at least one shift element for the rotationally fixed connection of two toothed gear wheels, whereby several power shiftable gears can be performed.

In accordance with the invention, the suggested double clutch transmission has preferably only five gear planes, with which at least eight power shiftable gears with a low construction space requirement can be realized. For example, the maximum of five gear planes can be created also through at least three dual wheel planes, whereby in each dual wheel plane an idler gear of the first and second countershafts each are allocated to a fixed gear of one of the input transmission shafts and whereby at least in one of the dual gear planes, at least one idler gear can be used for at least two gears, so that at least one winding path gear is shiftable via an activated winding path gear shift element.

For example, the five gear planes can be created exclusively through dual gear planes. It is also possible that in addition to the dual gear planes, at least one single gear plane can be used, whereby in each single gear plane an idler gear of the countershafts is allocated to a fixed gear of one of the transmission input shafts. Other constellations are also possible.

Because of the possible multiple applications of idler gears, a maximum number of ratios can be realized for the suggested double clutch transmission with as few gear planes as possible, while preferably the first eight forward gears are power shiftable during sequential execution.

To optimize the gradation for the suggested double clutch transmission of the invention, a dual gear plane can be replaced by two single gear planes, in that a fixed gear is replaced by two fixed gears. Thus, a particularly harmonious, progressive gear gradation can be achieved. It is also possible to replace two single gear planes with one dual gear plane.

Preferably, the suggested double clutch transmission can be designed as an 8-speed transmission with at least eight power shiftable step changes. Because of the short construction design as opposed to known gear designs, the double clutch transmission of the invention is particularly suitable for a front transversal design for a vehicle. However, other installation types are possible depending on the type and construction space of the respective vehicle.

Preferably, in the suggested double clutch transmission, the first and/or eighth forward gear can be a winding path gear. In addition, at least one reverse gear and/or other gears, such as crawler gears or overdrive gears can also be designed as winding path gears and possibly designed as power shiftable. For example, the first power-shiftable forward gear or the highest power shiftable gear can be a winding path gear. In addition to the winding path gear shift element placed on the first countershaft, other winding path gear shift elements can be optionally provided in form of one of the shift elements allocated to the second countershaft or also in form of coupling devices, which are more or less allocated as winding path gear shift elements to the constant pinion gear in order to disengage same from the allocated countershaft, in order to realize other winding path gears. Thus, both constant pinion gears can be optionally shiftable connected with the allocated countershaft.

For example, depending on design, three to five shiftable idler gears each may be allocated to the first countershaft and to the second countershaft, which idler gears each mesh with fixed gears of the allocated transmission input shafts.

If the last or second to last transmission ratio step is made higher than the one immediately preceding it, a particularly high output torque or input power can be provided for a downshift desired by the driver.

The double clutch transmission of the invention requires in an advantageous way a maximum of six shift positions on the first countershaft and a maximum of five shift positions on the second countershaft. Altogether, a maximum of nine shift positions together can be sufficient on both countershafts, to realize the suggested gear step. However, other shift positions are possible.

According to the invention it can be made feasible that via at least one additional shift element on the first and/or second countershaft, the idler gear of the second subtransmission is connectable with the idler gear of the first subtransmission, so that at least one winding path gear can be shifted via the shift element.

Thus, for the double clutch transmission with activated shift element and, if required, in addition with disengaged coupling devices, winding path gears can be realized on the output gears, where toothed gear wheels of both transmissions are connected to one another, in order to realize a power flow through both transmissions. The respectively used winding path gear shift element serves here to couple two idler gears and thus make the gear input shafts dependent on one another.

The arrangement of the shift elements to couple two specific idler gears in the double clutch transmission can be varied, so that shift elements must not be arranged between the idler gears to be coupled. Thus, other arrangement positions of the respective shift elements are possible, in order to optimize for example the linking to an actuator system.

According to a possible embodiment, it may be possible that for the double clutch transmission, for example, three dual gear planes and two single gear planes may be provided, while the fixed gears of the second gear input shaft of the second subtransmission are being allocated with a first gear plane, a second gear plane, and a third gear plane, and at the same time the fixed gears of the first gear input shaft of the first subtransmission are allocated a fourth gear plane and a fifth gear plane.

The first gear plane, the second gear plane and also the third gear plane of the second transmission, can be designed in this embodiment as a single gear plane as well as a dual gear plane. The fourth gear plane of the first subtransmission preferably designed as a dual gear plane and the fifth gear plane of the first subtransmission can be designed as a single gear plane as well as a dual gear plane.

Within the scope of another embodiment of the invention it can also be provided that for the suggested double clutch transmission, four dual gear planes and a single gear plane are provided. For example, the fixed gears of the second gear input shaft of the second subtransmission can be allocated with a first gear plane designed as a dual gear plane, a second gear plane designed as a single gear plane and a third wheel plane designed as a dual gear plane and the fixed gears of the first gear input shaft of the first subtransmission can be allocated a fourth gear plane and a fifth gear plane designed as a dual gear planes each.

Alternatively, in this embodiment, the fixed gears of the second gear input shaft of the second subtransmission can be allocated also with a first gear plane and a second gear plane respectively as dual gear planes and the fixed gears of the first gear input shaft of the first subtransmission can be allocated a third gear plane and a fourth gear plane respectively designed as a dual gear planes as well as a fifth gear plane designed as a single-gear plane.

Finally, it can also be provided for the double clutch transmission of the invention, that exclusively five dual gear planes can be realized. In addition, to the fixed gears of the second gear input shaft of the second subtransmission, a first gear plane and a second gear plane can be allocated each as dual gear planes and the fixed gears of the first gear input shaft of the first subtransmission can be allocated with a third gear plane, a fourth gear plane and a fifth gear plane each designed as a dual gear planes.

In order to provide the required reversal of drive to realize the reverse gears for the double clutch transmission of the invention, for example, at least an intermediate gear or similar may be used, which, e.g., is arranged on an intermediate shaft. It is also possible that one of the idler gears of a countershaft serves as intermediate gear for at least one reverse gear. That means that for the reverse gear ratio, no additional intermediate shaft is necessary, because one of the idler gears is engaged with a fixed gear as well as with another shiftable idler gear of the other countershaft. Thus, the intermediate gear necessary for the reverse gear is arranged on a countershaft as shiftable idler gear and serves also to realize at least one other forward gear. The intermediate gear may also be designed as a stepped gear independent of whether the same is arranged on the countershaft or on an additional intermediate shaft. It is also possible that the intermediate gear is not arranged on one of the already existing countershafts, but instead, for example, is provided on another separate shaft, e.g. a third countershaft.

In order to obtain the desired transmission ratio steps, the double clutch transmission of the invention can have at least a dual acting coupling devise or similar on each countershaft. The intended coupling devices can, depending on actuating direction in activated or engaged position connect one allocated idler gear each with the countershaft. Moreover, on at least one of the countershafts also a single acting coupling device or similar can be placed. As coupling devices can be used, for example, clutches that can be activated hydraulically, electrically, pneumatically, mechanically clutches or even positively engaged dog clutches as well as any type of synchronization device, which serve as a rotationally fixed connection of an idler gear with a countershaft. It is possible, that a dual acting coupling device can be replaced by two single acting coupling devices or vice versa.

It is conceivable that the given placement possibilities of the gear wheels will be varied and also the number of gear wheels as well as the number of coupling devices will be changed, in order to realize more power shiftable or non-power shiftable gears and construction space and component part savings for the suggested double clutch transmission. In particular, fixed gears of dual gear planes can be divided into two fixed gears for two single gear planes. Thus, step changes can be improved. Moreover, it is possible to exchange the countershafts. The transmissions can also be exchanged, that is, mirrored around a vertical axis. At the same time hollow shafts and solid shafts are exchanged. Thus, it is possible, for example, to place the smallest gear wheel on the solid shaft, to optimize further the utilization of the available construction space. Moreover, adjacent gear planes can be exchanged, for example, to optimize a shaft deflection and/or tie on optimally a shift an actuator system. Also, the respective placement position of the coupling device on the gear plane can be varied. In addition, the action direction of the coupling device can be changed.

The gear numberings used here were freely defined. It is also possible to add a crawler or creeper gear and/or an overdrive or fast gear, in order to improve for a vehicle, e.g. the off-road features or the acceleration behavior. Furthermore, for example, a first gear can be left out, e.g., to be able to better optimize the entirety of the step changes. During this step, the gear numbering varies accordingly.

Independent of the respective design variation of the double clutch transmissions, the input shaft and the output shafts preferably can also not be placed coaxially to one another, which realizes a particular installation-space-saving placement. For example, the shafts can be placed one after the other and displaced slightly from one another. With respect to this placement, a direct gear is possible with a ratio of one via gear tooth meshing and can advantageously be placed relatively freely on the sixth through ninth gear. Also other placement possibilities of the input shaft and output shaft are conceivable.

Preferably the suggested double clutch transmission will be equipped with an integrated output stage. The output stage as output gear wheel can comprise a fixed gear on the output shaft, which is engaged with a first output gear wheel as constant pinion of the first countershaft as well as with a second output gear wheel as constant pinion of the second countershaft. Optionally, both output gear wheels can be designed as shiftable gear wheels. To shift the respective output gear wheel, for example, a winding path gear coupling device can be allocated, which in opened state disengages the connection between the allocated countershaft and the output wheel, in order to be able to shift winding path gears.

In an advantageous manner, the lower forward gears and the reverse gears can be operated via a start-up clutch or shifting clutch, and thus higher loads can be concentrated on the clutch and, thus, the design of the second clutch can be made more economical as to construction space and cost effective. In particular, the gear planes of the suggested double clutch transmission can be positioned so that a start can be made either through the inner gear input shaft or even the outer gear input shaft and through the respectively better suited clutch, which can also be made possible with a concentrically placed, radially nested construction design of the double clutch. For that purpose, the gear planes can be mirror-symmetrically placed or exchanged.

Independent of the respective design variation, for example, the suggested gear planes can be exchanged in the double clutch transmission.

### BRIEF DESCRIPTION OF THE DRAWINGS

Below, the present invention will be explained in particular with the help of the drawings as follows:

FIG. 1 is a schematic view of one first variant embodiment of an 8-speed double clutch transmission of the invention;

FIG. 2 is a gear shift pattern of the first variant embodiment according to FIG. 1;

FIG. 3 is a schematic view of a second variant embodiment of the 8-speed double clutch transmission of the invention;

FIG. 4 is a gear shift pattern of the second variant embodiment according to FIG. 3;

FIG. 5 is a schematic view of a third embodiment version of the 8-speed double clutch transmission;

FIG. 6 is a gear shift pattern of the third variant embodiment according to FIG. 5;

FIG. 7 is a schematic view of a fourth variant embodiment of the 8-speed double clutch transmission of the invention;

FIG. 8 is a gear shift pattern of the fourth variant embodiment according to FIG. 7;

FIG. 9 is a schematic view of a fifth variant embodiment of the 8-speed double clutch transmission of the invention;

FIG. 10 is a gear shift pattern of the fifth variant embodiment according to FIG. 9;

FIG. 11 is a schematic view of a sixth variant embodiment of the 9-speed double clutch transmission of the invention;

FIG. 12 is a gear shift pattern of the sixth variant embodiment according to FIG. 11;

FIG. 13 is a schematic view of a seventh variant embodiment of the 8-speed double clutch transmission of the invention; and

FIG. 14 is a gear shift pattern of the seventh variant embodiment according to FIG. 13.

FIG. 15 is schematic view of an eighth variant embodiment of the 8-speed double clutch transmission of the invention;

FIG. 16 is a gear shift pattern of the eighth variant embodiment according to FIG. 15;

FIG. 17 is a schematic view of a ninth variant embodiment of the 8-speed double clutch transmission of the invention;

FIG. 18 is a gear shift pattern of the ninth variant embodiment according to FIG. 17;

FIG. 19 is a schematic view of a tenth variant embodiment of the 8-speed-double clutch transmission of the invention;

FIG. 20 is a gear shift pattern of the tenth variant embodiment according to FIG. 19;

FIG. 21 is a schematic view of an eleventh variant embodiment of the 8-speed double clutch transmission of the invention;

FIG. 22 is a gear shift pattern of the eleventh variant embodiment according to FIG. 21;

FIG. 23 is a schematic view of a twelfth variant embodiment of the 8-speed double clutch transmission of the invention;

FIG. 24 is a gear shift pattern of the twelfth variant embodiment according to FIG. 23;

FIG. 25 is a schematic view of a thirteenth variant embodiment of the 8-speed double clutch transmission of the invention;

FIG. 26 is a gear shift pattern of the thirteenth variant embodiment according to FIG. 25;

FIG. 27 is a schematic view of a fourteenth variant embodiment of the 8-seed double clutch transmission of the invention;

FIG. 28 is a gear shift pattern of the fourteenth variant embodiment according to FIG. 27;

FIG. 29 is a schematic view of a fifteenth variant embodiment of the 8-speed double clutch transmission of the invention; and

FIG. 30 is a gear shift pattern of the fifteenth variant embodiment according to FIG. 29.

### DETAILED DESCRIPTION OF THE PREFERRED EMBODIMENTS

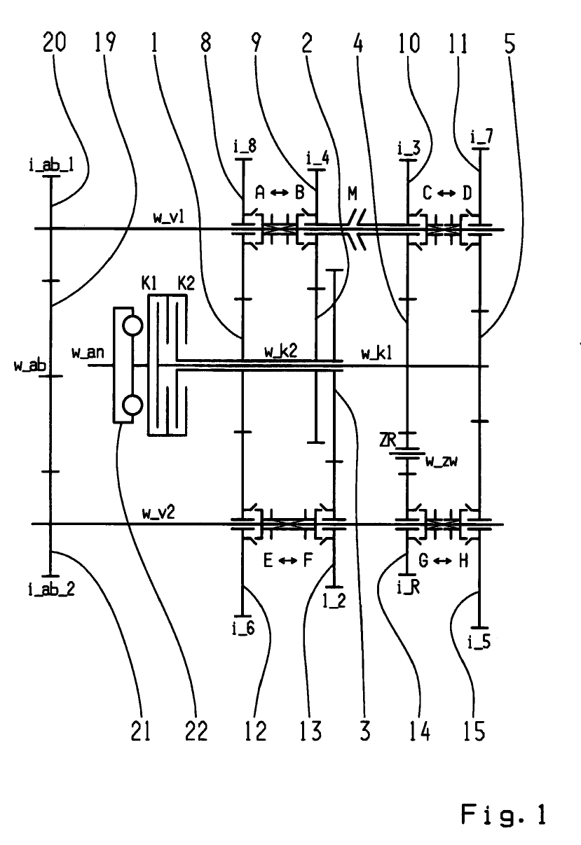

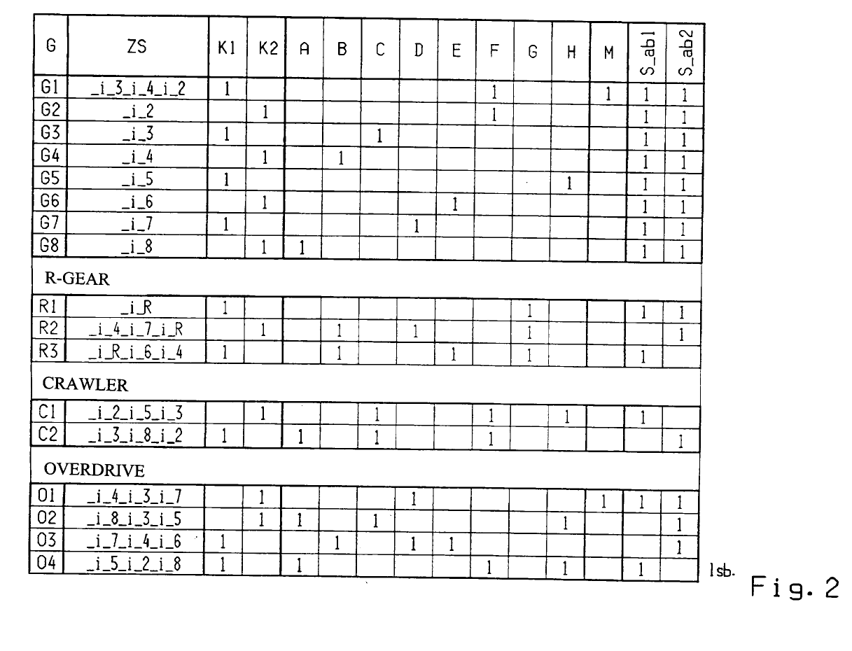

FIGS. 1, 3, 5, 7, 9, 11, 13, 15, 17, 19, 21, 23, 25, 27 and 29 each show a possible variant embodiment of an 8-speed double clutch transmission. The respective gear shift patterns of the various variant embodiments are shown in table form in FIGS. 2, 4, 6, 8, 10, 12, 14, 16, 18, 20, 22, 24, 26, 28 and 30.

The 8-speed double clutch transmission comprises two clutches K1, K2, the input sides of which are connected with an input shaft w_an and the output sides of which are connected respectively with one of two coaxially to one another placed transmission input shafts w_k1, w_k2. Moreover, a torsion vibration damper 22 can be placed at the input shaft w_an. In addition, two countershafts w_v1, w_v2 are provided, on which are positioned toothed gear wheels designed as idler wheels 7, 8, 9, 10, 11, 12, 13, 14, 15, 16, 17, 18. On both transmission input shafts w_k1, w_k2 are positioned in a rotationally fixed manner toothed gear wheels designed as fixed gears 1, 2, 3, 4, 5, 6, that at least in part are meshed the idler gears 7, 8, 9, 10, 11, 12, 13, 14, 15, 16, 17, 18.

In order to connect the idler gears 7, 8, 9, 10, 11, 12, 13, 14, 15, 16, 17, 18 with the respective countershafts w_v1, w_v2, several coupling devices A, B, C, D, E, F, G, H, I, J, K, L, that can be activated, are provided on the countershafts w_v1, w_v2. Also on the two countershafts w_v1, w_v2, are positioned as constant pinions, output gear wheels 20, 21, which are coupled each with gearing of a fixed gear 19 of an output shaft w_ab, whereby output gear wheels 20, 21 are allocated respectively output stages i_ab_1, i_ab_2.

In addition to the coupling devices A, B, C, D, E, F, G, H, I, J, K, L, that realize in activated state a rotationally fixed connection between a toothed gear wheel and the allocated counter shares w_v1, w_v2, there is on the first countershaft w_v1 a winding path gear shift element M. The shift element M connects idler gears 9 and 10 of the first countershaft w_v1 with one another, in order to couple the first subtransmission with the second subtransmission, so that the winding path gears are shiftable.

According to the invention, the double clutch transmission has only five gear planes 7-1, 7-13, 8-12, 8-14, 9-2, 9-15, 1-13, 3-13, 2-14, 10-14, 1-15, 9-15, 10-16, 11-5, 5-17, 11-17, 6-18, 12-6, 12-18, and each variant embodiment has at least three dual gear planes 7-13, 8-12, 8-14, 10-14, 9-15, 10-16, 11-15, 11-17, 12-18, so that the winding path gears are shiftable at least during activated shift element M and, if required, also through another activated shift element N, and through at least on of the winding path gear coupling devices S_ab1, S_ab2. As shift the element M, N respectively, a claw or alike can be used to connect two gear wheels.

If the coupling device S_ab1 or S_ab2 is disengaged, the rotationally fixed connection between the output gear wheel 20 or 21 and the first countershaft w_v1 or the second countershaft w_v2 can be disengaged. For the double clutch transmission, if required, the winding path gear shift element N can provide a rotationally fixed connection between the idler gears 13 and 14 of the second countershaft w_v2, so that through the activated shift element N, at least one winding path gear can be realized.

In the first embodiment version according to FIGS. 1 and 2, the fixed gear 1 of the second transmission input shaft w k2 meshes at the first gear plane 8-12 designed as a dual gear plane not only with the idler gear 12 of the second countershaft w_v2, but also with the idler gear 8 of the first countershaft w_v1. In the second gear plane 9-2 designed as a single gear plane, the fixed gear 2 of the second transmission input shaft w_k2 meshes with the idler gear 9 of the first countershaft w_v1. In the third gear plane 3-13 designed as a single gear plane, the fixed gear 3 of the second transmission input shaft w_k2 meshes with the idler gear 13 of the second countershaft w_v2. Moreover, in the fourth gear plane 10-14 designed as a dual gear plane, the fixed gear 4 of the first transmission input shaft w_k1 meshes with the idler gear 10 of the first countershaft w_v1 as well as with one intermediate gear ZR on an intermediate shaft w_zw to reverse the rotation for the reverse gear ratios, while the intermediate gear ZR also meshes with the idler gear 14 of the second countershaft w_v2. In the fifth gear plane 11-15 designed as a dual gear plane, the fixed gear 5 meshes with the first transmission input shaft w_k1 as well as with the idler gear 11 of the first counter shaft w_v1 as well as with the idler gear 15 of the second counter shaft w_v2.

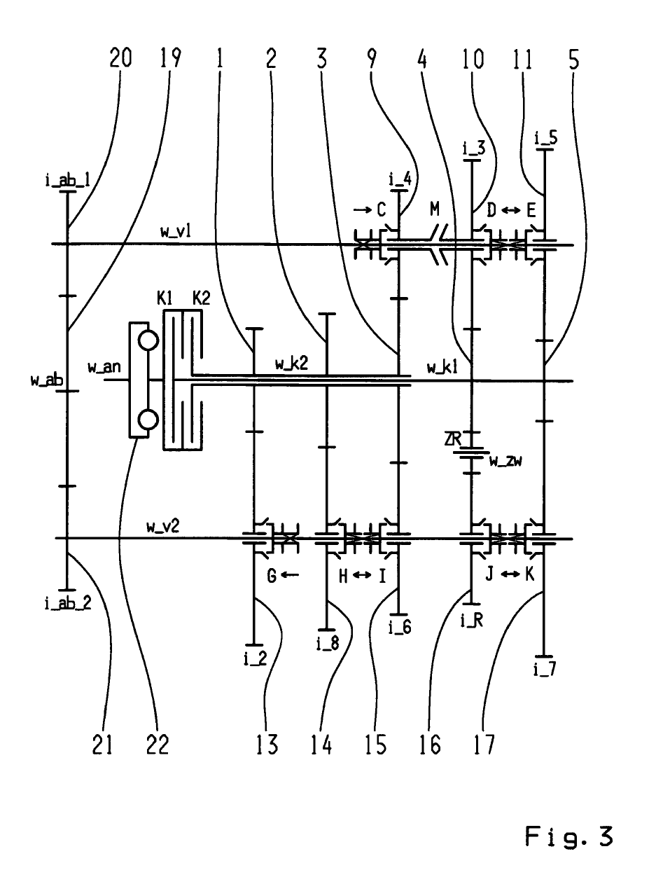

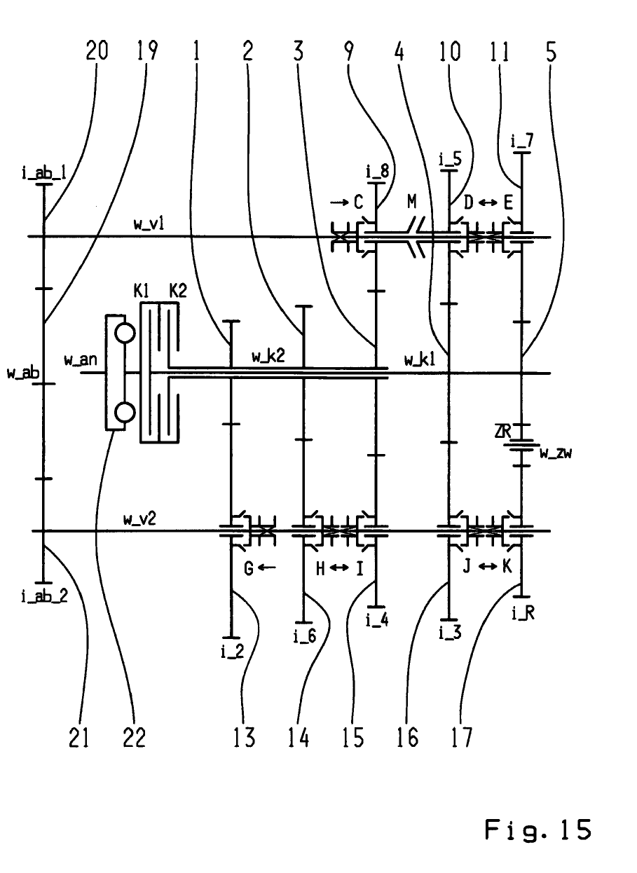

In the embodiment versions 2 and 8 according to FIGS. 3 and 15, in the first gear plane 1-13 designed as a single gear plane, the fixed gear 1 of the second transmission input shaft w_k2 meshes with idler gear 13 of the second countershaft w_v2. In the second gear plane 2-14 designed as a single gear plane, the fixed gear 2 of the second transmission input shaft w_k2, meshes with idler gear 14 of the second countershaft w_v2. In the third gear plane 9-15 designed as a dual gear plane, the fixed gear 3 of the second transmission input shaft w_k2 meshes not only with the idler gear 9 of the first countershaft w_v1, but also with the idler gear 15 of the second countershaft w_v2. In the second variant embodiment, the fourth gear plane 10-16 designed as a dual gear plane, the fixed gear 4 of the first transmission input shaft w_k1 meshes not only with the idler gear 10 of the first countershaft w_v1, but also with the intermediate gear ZR on the intermediate shaft w_zw, to reverse the rotation for the reverse gear ratios, while the intermediate gear ZR meshes in addition thereto with the idler gear 16 of the second countershaft w_v2. Finally, in the second embodiment version in the fifth gear plane 11-17 designed as a dual gear plane, fixed gear 5 meshes not only with the idler gear 11 of the first countershaft w_v1, but also with the idler gear 17 of the second countershaft w_v2. In the eighth variant embodiment in the fourth gear plane 10-16, the fixed gear 4 of the first transmission input shaft w_k1 meshes not only with the idler gear 10 of the first countershaft w_v1, but also with the idler gear 16 of the second countershaft w_v2. In the fifth gear plane 11-17 designed as a dual gear plane in the eight variant embodiment, fixed gear 5 meshes not only with the idler gear 11 of the first countershaft w_v1, but also with the intermediate gear ZR on the intermediate shaft w_zw to reverse the rotation for the reverse gear ratios, while the intermediate gear ZR meshes also with the idler gear 17 of the second countershaft w_v2.

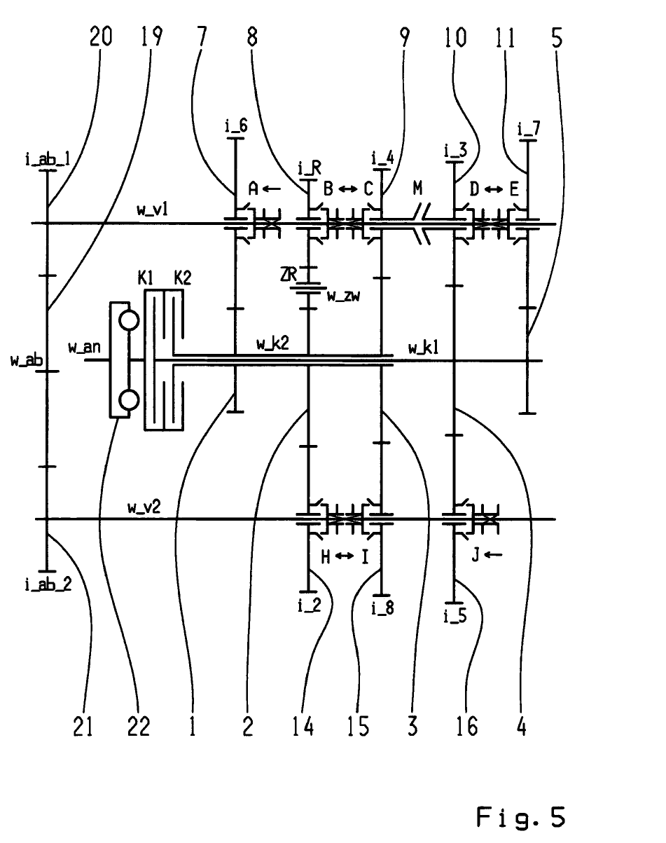

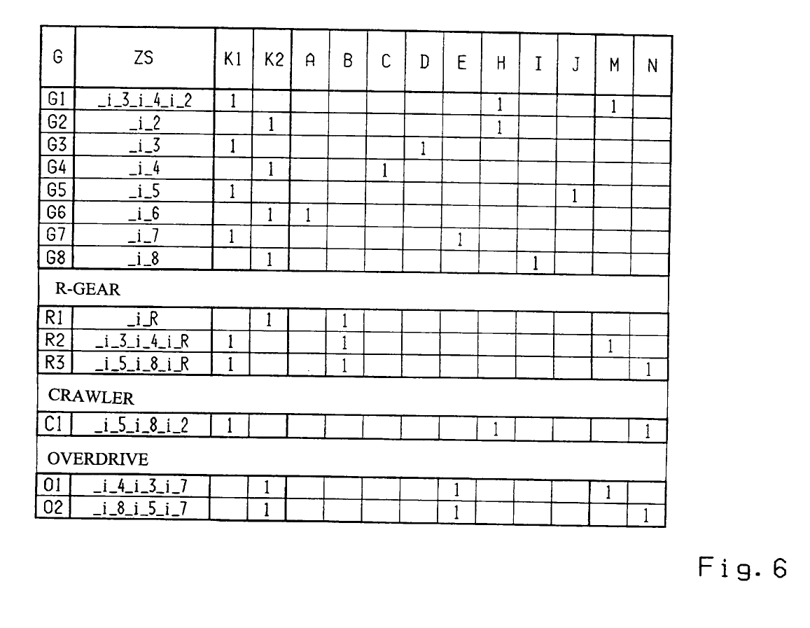

In the third variant embodiment according to FIGS. 5 and 6 in the first gear plane 7-1 designed as a single gear plane, the fixed gear 1 of the second transmission input shaft w_k2 meshes with idler gear 7 of the first countershaft w_v1. In the second gear plane 8-14 designed as a dual gear plane, fixed gear 2 of the second transmission input shaft w_k2 meshes with the intermediate gear ZR on intermediate shaft w_zw, to reverse the rotation for the reverse gear ratios, while the intermediate gear ZR meshes in addition thereto with idler gear 8 of the first countershaft w_v1. In addition, fixed gear 2 of the second transmission input shaft w_k2 meshes also with the idler gear idler gear 14 of the second countershaft w_v2. In the third gear plane 9-15 designed as a dual gear plane meshes the fixed gear 3 of the second transmission input shaft w_k2 not only with the idler gear 9 of the first countershaft w_v1, but also with the idler gear 15 of the second countershaft w_v2. In the fourth gear plane 10-16 designed as a dual gear plane meshes the fixed gear 4 of the first transmission input shaft w_k1 not only with the idler gear 10 of the first countershaft w_v1, but also with the idler gear 16 of the second countershaft w_v2. Finally, in the fifth gear plane 11-5 designed as a single gear plane, the fixed gear plane 5 of the first transmission input shaft w_k1 meshes with idler gear 11 of the first countershaft w_v1.

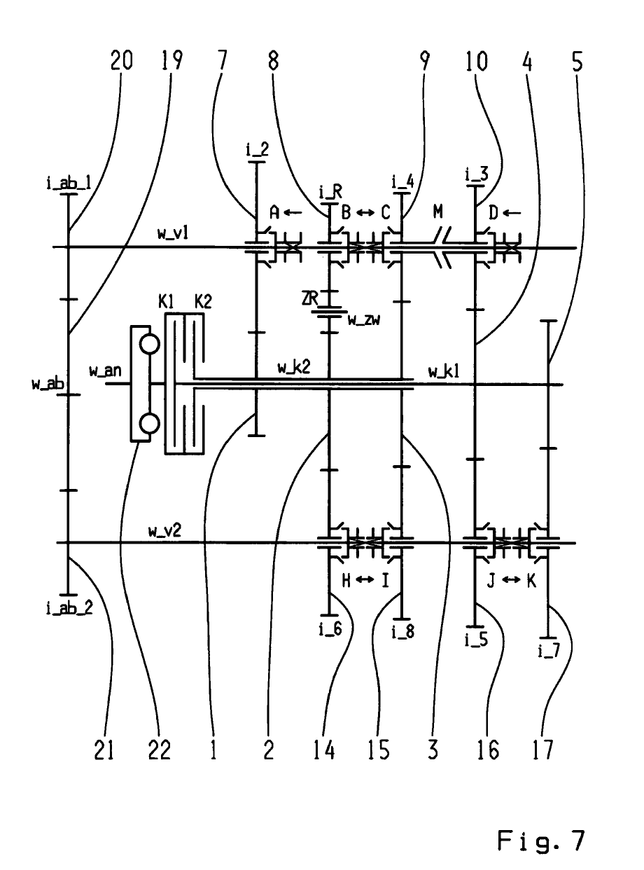

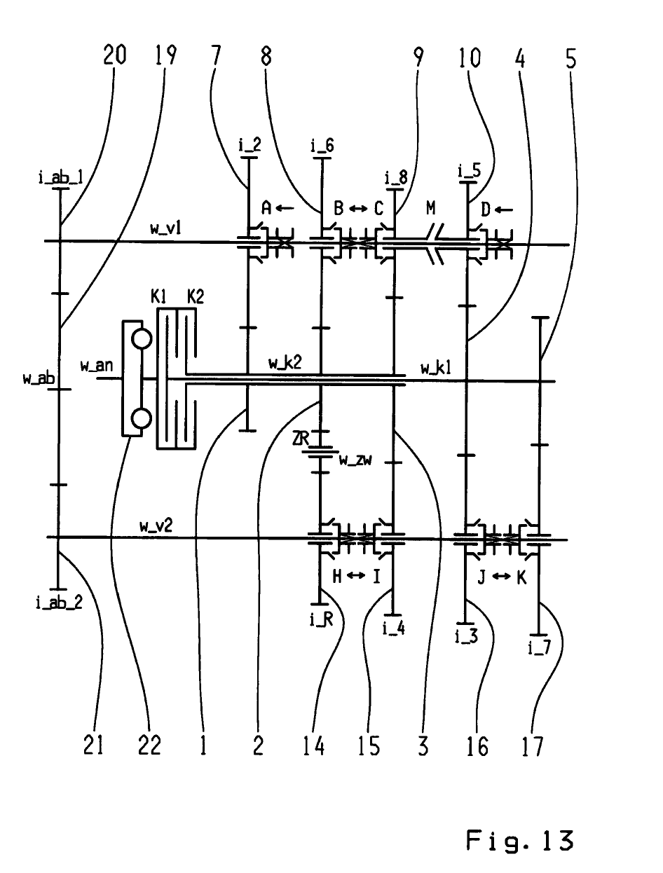

In the 4th and 7th variant embodiments according to FIGS. 7 and 13, the fixed gear 1 of the second transmission input shaft w_k2 designed as a single gear plane meshes in the first gear plane 7-1, with the idler gear 7 of the first countershaft w_v1. In the 4th variant embodiment in the second gear plane 8-14 designed as a dual wheel plane, the fixed gear 2 of the second transmission input shaft w_k2 meshes not only with the idler gear 14 of the second countershaft w_v2, but also with the intermediate gear ZR on the intermediate shaft w_zw, to reverse the rotation for the reverse gear ratios reverse gear ratios, while the intermediate gear ZR also meshes with the idler gear 8 on the first countershaft w_v1. Contrary thereto, in the 7th variant embodiment in the second gear plane 8-14 designed as a dual gear plane, the fixed gear 2 meshes not only with the idler gear 8 of the first countershaft w_v1, but also with the intermediate gear intermediate gear ZR on the intermediate shaft w_zw, while the intermediate gear ZR meshes in addition thereto with the idler gear 14 of the second countershaft w_v2. Moreover, in the 4th and 7th variant embodiments in the third gear plane 9-15 designed as a dual gear plane, the fixed gear 3 of the second transmission input shaft w_k2 meshes not only with the idler gear 9 of the first countershaft w_v1, but also with the idler gear 15 of the second countershaft w_v2. In the fourth gear plane 10-16 designed as a dual gear plane, the fixed gear 4 of the first transmission input shaft w_k1 meshes not only with the idler gear 10 of the first countershaft w_v1, but also with the idler gear 16 of the second countershaft w_v2. Finally, in the fifth gear plane 5-17 designed as a single gear plane, the fixed gear 5 of the first transmission input shaft w_k1 meshes only with the idler gear 17 of the second countershaft w_v2.

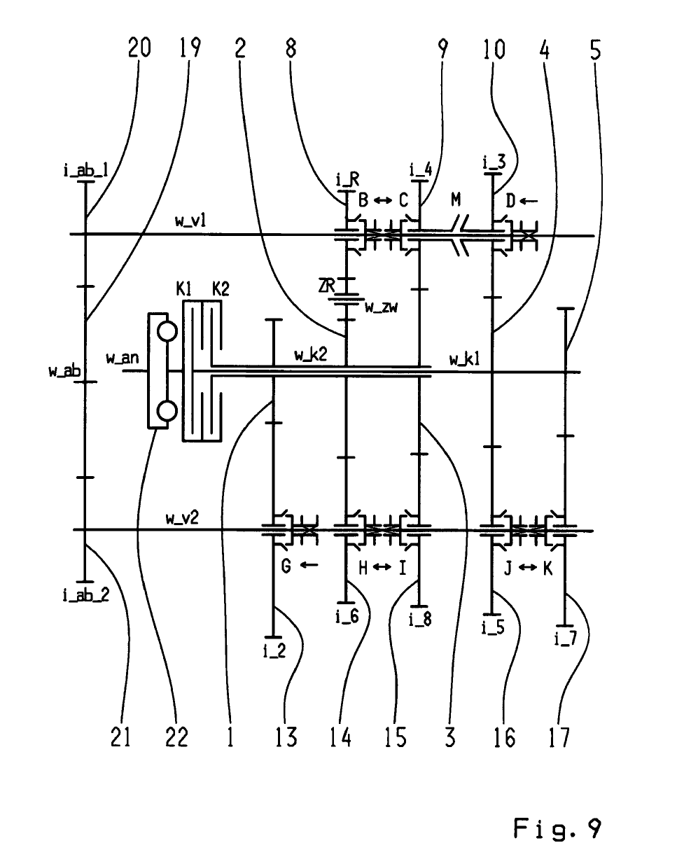

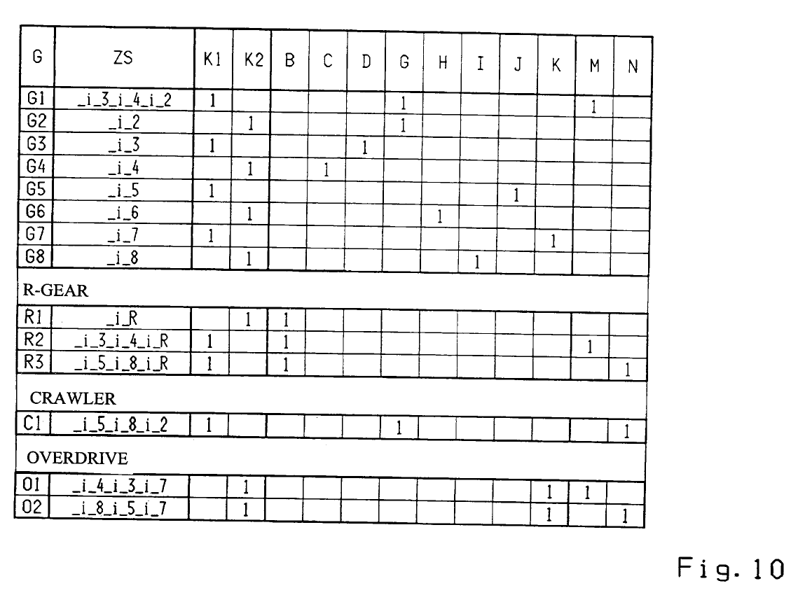

In the 5th variant embodiment according to FIGS. 9 and 10 in the first gear plane 1-13 designed as a single gear plane, the fixed gear 1 of the second transmission input shaft w_k2 meshes only with the idler gear 13 of the second countershaft w_v2. In the second gear plane 8-14 designed as a dual gear plane, the fixed gear 2 of the second transmission input shaft w_k2 meshes not only with the idler gear 14 of the second countershaft w_v2, but also with the intermediate gear ZR on the intermediate shaft w_zw to reverse the rotation for the reverse gear ratios, while the intermediate gear ZR meshes in addition thereto with the idler gear 8 on the first countershaft w_v1. In the third gear plane 9-15 designed as a dual gear plane the fixed gear 3 of the second transmission input shaft w_k2 meshes not only with the idler gear 9 of the first countershaft w_v1, but also with the idler gear 15 of the second countershaft w_v2. In the fourth gear plane 10-16 designed as a dual gear plane, the fixed gear 4 of the first transmission input shaft w_k1 meshes not only with the idler gear 10 of the first countershaft w_v1, but also with the idler gear 16 of the second countershaft w_v2. Finally, in the fifth gear plane 5-17 designed as a single gear plane, the fixed gear 5 of the first transmission input shaft w_k1 meshes only with the idler gear 17 of the second countershaft w_v2.

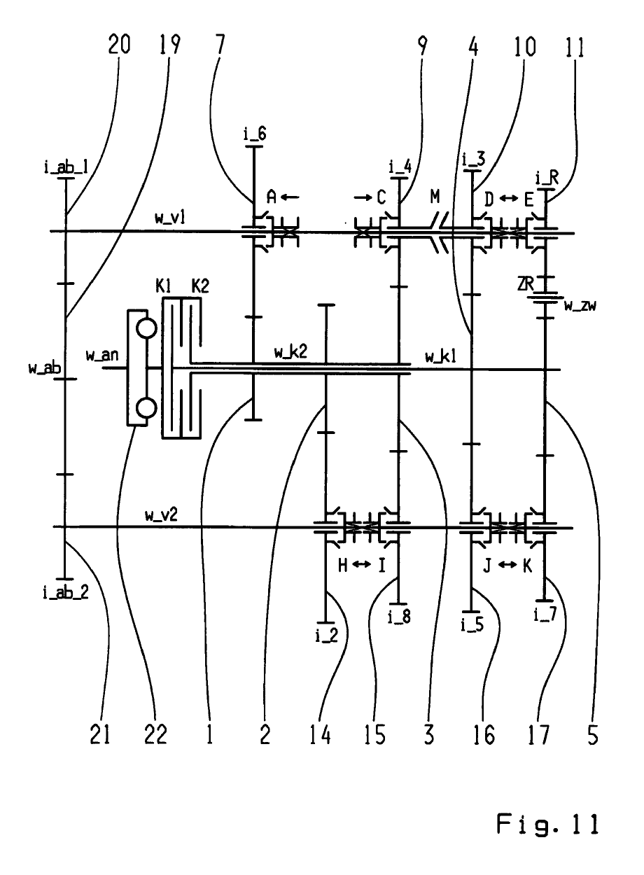

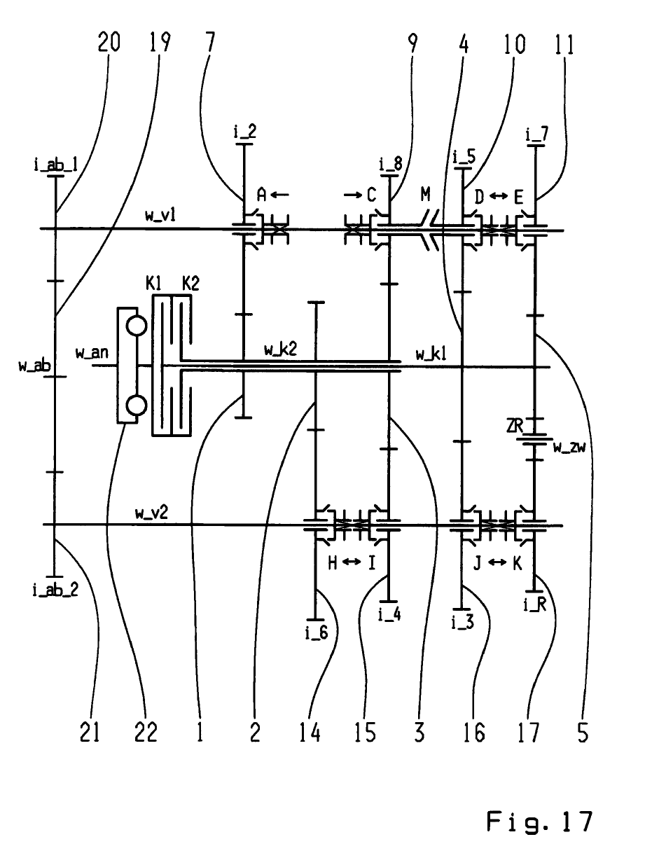

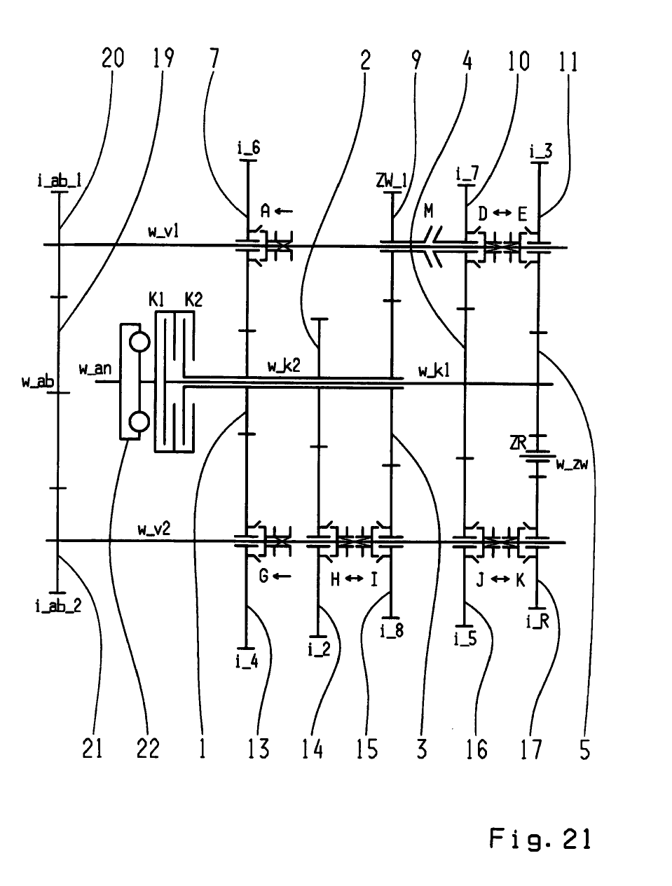

In the 6th and 9th variant embodiments according to FIGS. 11 and 17 in the first gear plane 7-1 designed as a single gear plane, the fixed gear 1 of the second transmission input shaft w_k2 meshes with the idler gear 7 of the first countershaft w_v1. Contrary thereto, in the 11th variant embodiment according to FIG. 21 in the first gear plane 7-13 designed as a dual gear plane, the fixed gear 1 of the second transmission input shaft w_k2 meshes not only with the idler gear 7 of the first countershaft w_v1, but also with the idler gear 13 of the second countershaft w_v2. In the second gear plane 2-14 designed as a single gear plane in the 6th, 9th and 11th variant embodiment, the fixed gear 2 of the second transmission input shaft w_k2 meshes with the idler gear 14 of the second countershaft w_v2. In the third gear plane 9-15 designed as a dual gear plane, the fixed gear 3 of the second transmission input shaft w_k2 meshes not only with the idler gear 9 of the first countershaft w_v1, but also with the idler gear 10 of the second countershaft w_v2. In the fourth gear plane 10-16 designed as a dual gear plane, the fixed gear 4 of the first transmission input shaft w_k1 meshes not only with the idler gear 10 of the first countershaft w_v1, but also with the idler gear 16 of the second countershaft w_v2. In the 6th variant embodiment in the fifth gear plane 11-17, the fixed gear 5 of the first transmission input shaft w_k1 meshes not only with the idler gear 17 of the second countershaft w_v2, but also with the intermediate gear ZR on the intermediate shaft w_zw, while the intermediate gear ZR in addition thereto meshes with the idler gear 11 of the first countershaft w_v1. Contrary thereto, in the 9th and 11th variant embodiment in the fifth gear plane 11-17 designed as a dual gear plane, the fixed gear 5 of the first transmission input shaft w_k1 meshes not only with the idler gear 11 of the first countershaft w_v1, but also with the intermediate gear ZR on the intermediate shaft w_zw to reverse the rotation for the reverse gear ratio, while the intermediate gear ZR also meshes with the idler gear 17 of the second countershaft w_v2.

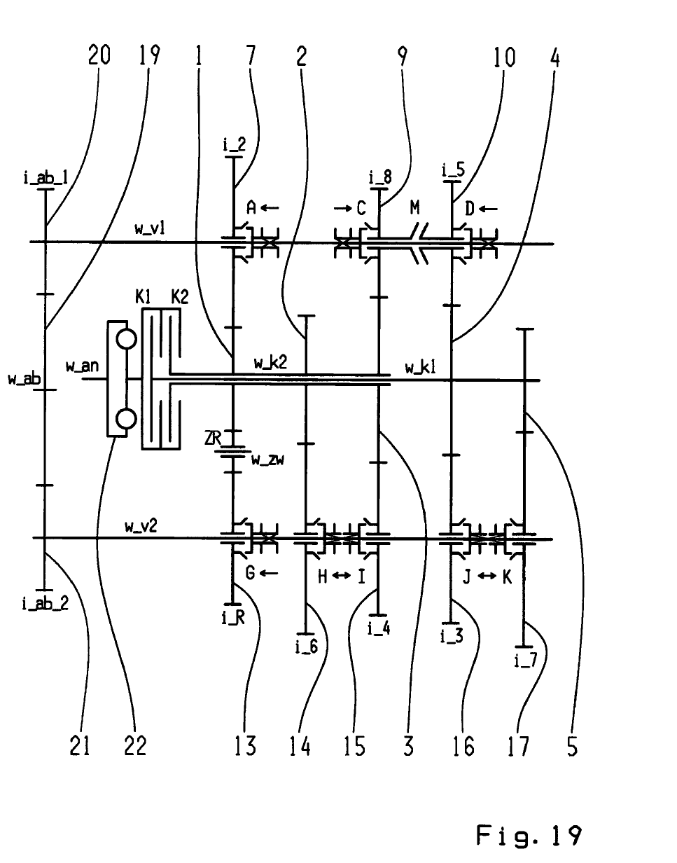

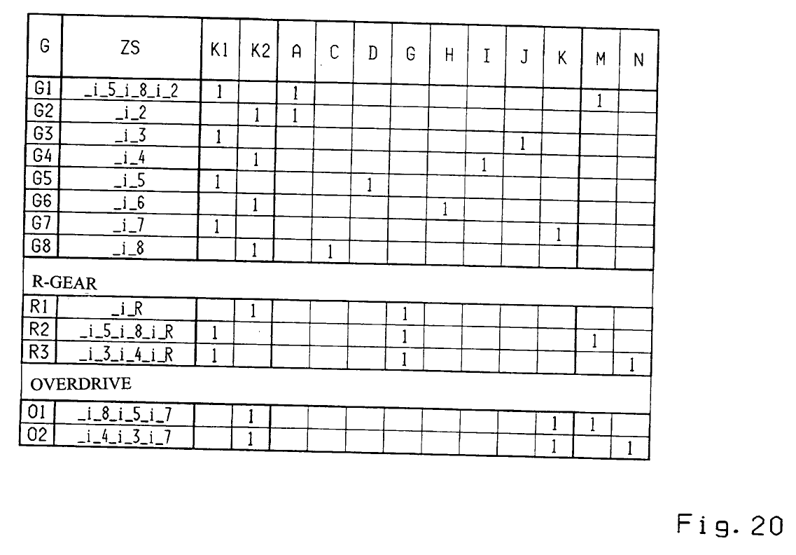

In the 10th variant embodiment according to FIGS. 19 and 20 in the first gear plane 7-13 designed as a dual gear plane, the fixed gear 1 of the second transmission input shaft w_k2 meshes not only with the idler gear 7 of the first countershaft w_v1, but also with the intermediate gear ZR of the intermediate shaft w_zw to reverse the rotation for the reverse gear ratios, while the intermediate gear ZR meshes with the idler gear 13 of the second countershaft w_v2. In the second gear plane 2-14 designed as a single gear plane, the fixed gear 2 of the second transmission input shaft w_k2 meshes with the idler gear 14 of the second countershaft w_v2. In the third gear plane 9-15 designed as a dual gear plane, the fixed gear 3 of the second transmission input shaft w_k2 meshes not only with the idler gear 9 of the first countershaft w_v1, but also with the idler gear 15 of the second countershaft w_v2. In the fourth gear plane 10-16 designed as a dual gear plane, the fixed gear 4 of the first transmission input shaft w_k1 meshes not only with the idler gear 10 of the first countershaft w_v1, but also with the idler gear 16 of the second countershaft w_v2. Finally, in the fifth gear plane 5-17, the fixed gear 5 of the first transmission input shaft w_k1 meshes with the idler gear 17 of the second countershaft w_v2.

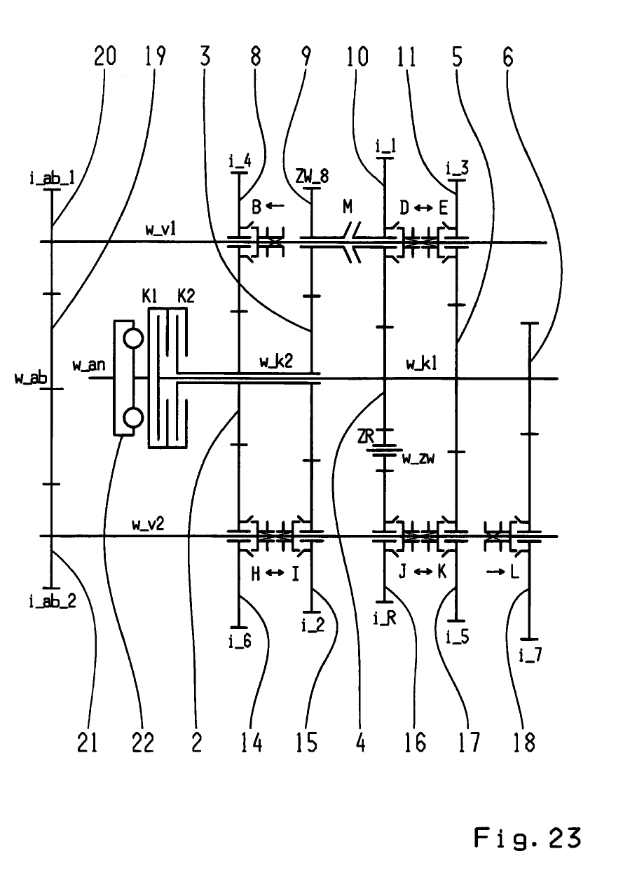

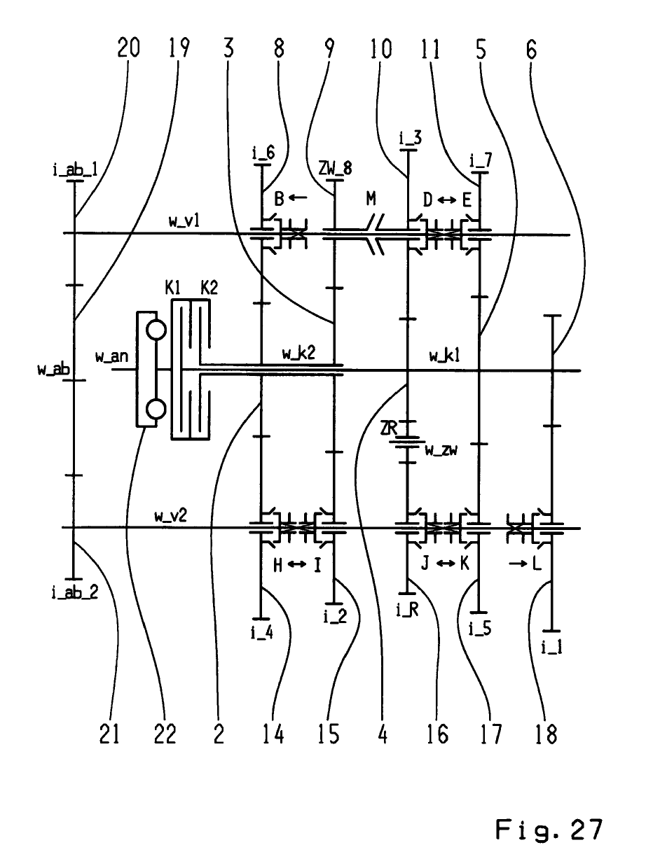

In the 12th and 14th variant embodiments according to FIGS. 23 and 27, in the first gear plane 8-14 designed as a dual gear plane, the fixed gear 2 of the second transmission input shaft w_k2 meshes not only with the idler gear 8 of the first countershaft w_v1, but also with the idler gear 14 of the second countershaft w_v2. In the second gear plane 9-15 designed as a dual gear plane, the fixed gear 3 of the second transmission input shaft w_k2 meshes not only with the idler gear 9 of the first countershaft w_v1, but also with the idler gear 15 of the second countershaft w_2. In the third gear plane 10-16 designed as a dual gear plane, the fixed gear 4 of the first transmission input shaft w_k1 meshes not only with the idler gear 10 of the first countershaft w_v1, but also with the intermediate gear ZR of the intermediate shaft w_zw to reverse the rotation for the reverse gear ratios, while the intermediate gear ZR meshes with idler gear 16 of the second countershaft w_v2. In the fourth wheel plane 11-17 designed as a dual gear plane, the fixed gear 5 of the first transmission input shaft w_k1 meshes not only with the idler gear 11 of the first countershaft w_v1, but also with the idler gear 17 of the second countershaft w_v2. Finally, in the fifth gear plane 6-18 designed as a single gear plane, the fixed gear 6 of the first transmission input shaft w_k1 meshes with the idler gear 18 of the second countershaft w_v2.

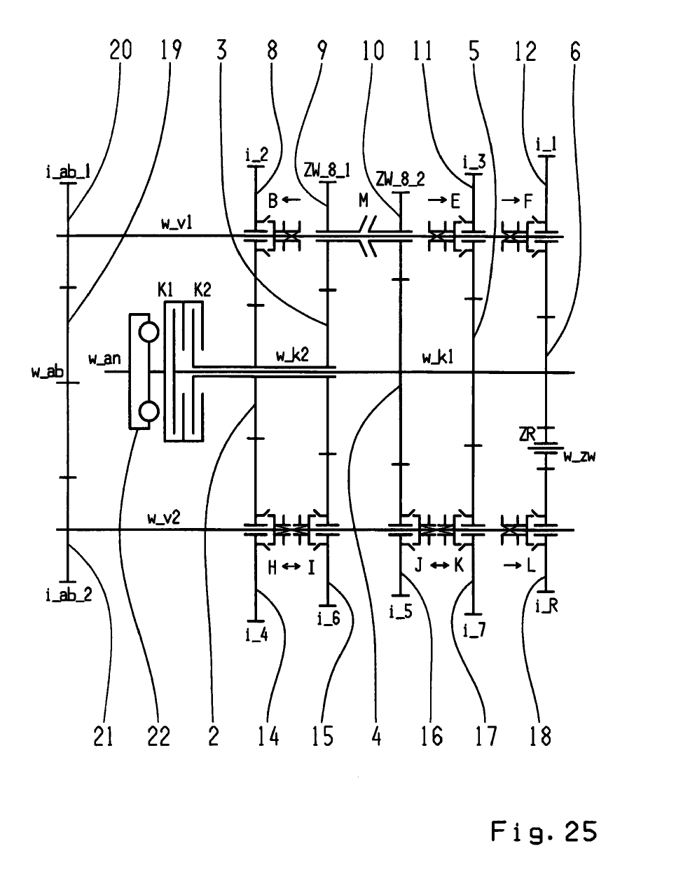

In the 13th variant embodiment according to FIG. 25 in the first gear plane 8-14 designed as a dual gear plane, the fixed gear 2 of the second transmission input shaft w_k2 meshes not only with the idler gear 8 of the first countershaft w_v1, but also with the idler gear 14 of the second countershaft w_v2. In the second gear plane 9-15 designed as a dual gear plane, the fixed gear 3 of the second transmission input shaft w_k2 meshes not only with the idler gear 9 of the first countershaft w_v1, but also with the idler gear of the second countershaft w_v2. In the third gear plane 10-16 designed as a dual gear plane the fixed gear 4 of the first transmission input shaft w_k1 meshes not only with the idler gear 10 of the first countershaft w_v1, but also with the idler gear 16 of the second countershaft w_v2. In the fourth gear plane 11-17 designed as a dual gear plane, the fixed gear 5 of the first transmission input shaft w_k1 meshes not only with the idler gear 11 of the first countershaft w_v1, but also with the idler gear 17 of the second countershaft w_v2. Finally, in the fifth gear plane 12-18 designed as a dual gear plane, the fixed gear 6 of the first transmission input shaft w_k1 meshes not only with the idler gear 12 of the first countershaft w_v1, but also with the intermediate gear ZR of the intermediate shaft w_zw to reverse the rotation for the reverse gear ratios, while the intermediate gear ZR meshes with idler gear 18 of the second countershaft w_v2.

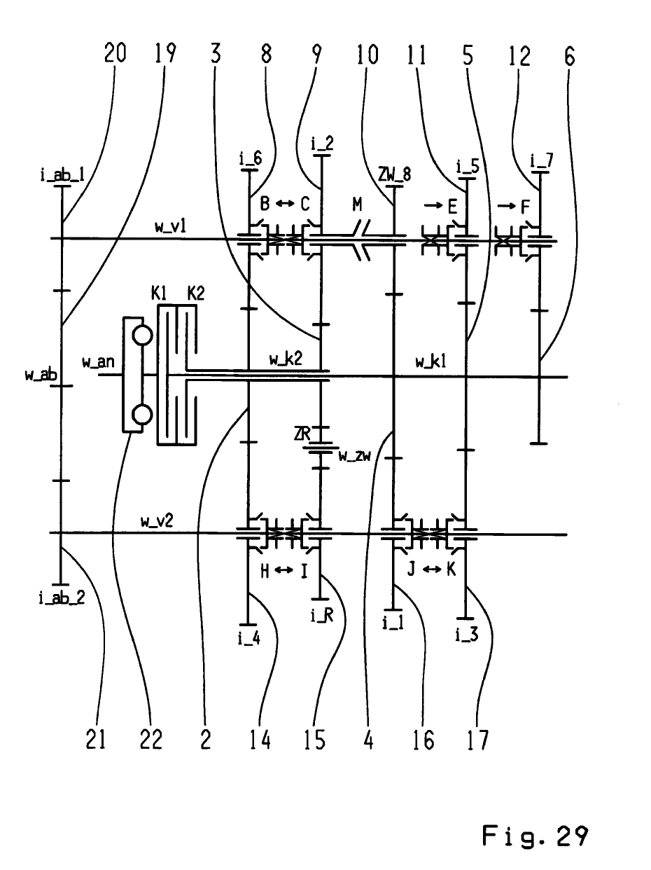

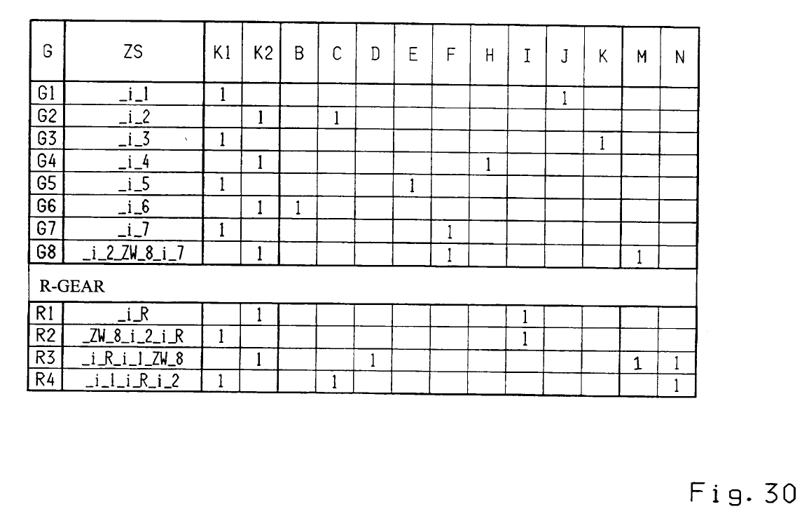

In the 15th variant embodiment according to FIGS. 29 and 30 in the first gear plane 8-14 designed as a dual gear plane, the fixed gear 2 of the second transmission input shaft w_k2 meshes not only with idler gear 8 of the first countershaft w_v1, but also with the idler gear 14 of the second countershaft w_v2. In the second gear plane 9-15 designed as a dual gear plane, the fixed gear 3 of the second transmission input shaft w_k2 meshes not only with the idler gear 9 of the first countershaft w_v1, but also with the intermediate gear ZR on the intermediate shaft w_zw to reverse the rotation for the reverse gear ratios, while the intermediate gear ZR in addition thereto meshes with the idler gear 15 of the second countershaft w_v2. In the third gear plane 10-16 designed as a dual gear plane, the fixed gear 4 of the first transmission input shaft w_k1 meshes not only with the idler gear 10 the first countershaft w_v1, but also with the idler gear 16 of the second countershaft w_v2. In the fourth gear plane 11-17 designed as a dual gear plane, the fixed gear 5 of the first transmission input shaft w_k1 meshes not only with the idler gear 11 of the first countershaft w_v1, but also with the idler gear 17 of the second countershaft w_v2. Finally, in the fifth gear plane 12-6 designed as a single gear plane, the fixed gear 6 of the first transmission input shaft w_k1 meshes only with the idler gear 12 of the first countershaft w_v1.

In the 1st variant embodiment according to FIG. 1 there are placed on the first countershaft w_v1 two dual action coupling devices A-B and C-D, while the coupling devices A-B and C-D are placed in such a way that the activated coupling device A connects idler gear 8, the activated coupling device B connects idler gear 9, the activated coupling device C connects the idler gear 10 and the activated coupling device D connects the idler gear 11 each firmly with the first countershaft w_v1. Moreover, there are on the second countershaft w_v2 also two dual action coupling devices E-F and G-H, while the coupling devices E-F and G-H are placed in such a way that the activated coupling device E connect the idler gear 12, the activated coupling device F connects the idler gear 13, the activated coupling device G connects the idler gear 14 and the activated coupling device H connects the idler gear 15 each firmly with the second countershaft w_v2.

In the 2nd and 8th variant embodiments according to FIGS. 3 and 15, there are placed on the first countershaft w_v1 dual action coupling devices D-E and a single action coupling device C, while the coupling devices D-E and C are placed in such a way that the activated coupling device C connects the idler gear 9, the activated coupling device D connects the idler gear 10 and the activated coupling device E connects the idler gear 11 each firmly with the first countershaft w_v1. On the second countershaft there are two dual action coupling devices H-I and J-K as well as a single action coupling device G, while the coupling devices H-I, J-K and G are placed in such a way that the activated coupling device G connects the idler gear 13, the activated coupling device H connects the idler gear 14, the activated coupling device I connects the idler gear 15, the activated coupling device J connects the idler gear 16 and the activated coupling device K connects the idler gear 17 each firmly with the second countershaft w_v2.

In the 3rd variant embodiment according to FIG. 5 there are provided on the first countershaft two dual action coupling devices B-C and D-E as well as a single following coupling device A, while the coupling devices B-C, D-E and A are placed in such a way that the activated coupling device A connects the idler gear 7, the activated coupling device B connects the idler gear 8, the activated coupling device C connects the idler gear 9, the activated coupling device D connects the idler gear 10 and the activated coupling device E connects the idler gear 11 each firmly with the first countershaft w_v1. On the second countershaft w_v2 there are provided a dual action coupling devices H-I and a single coupling device J, while the coupling devices H-I and J are placed in such a way that the activated coupling device H connects the idler gear 14, the activated coupling device I the idler gear 15 and the activated coupling device J the idler gear 16 each firmly with the second countershaft w_v2.

In the 4th and 7th variant embodiments according to FIGS. 7 and 13 there are provided on the first countershaft w_v1 a dual action coupling device B-C and two single action coupling devices A and D, while the coupling devices B-C, A and D are placed in such a way that the activated coupling device A connects the idler gear 7, the activated coupling device B connects the idler gear 8, the activated coupling device C connects the idler gear 9 and the activated coupling device D connects the idler gear 10 each firmly with the first countershaft w_v1. On the second countershaft there are provided two dual action coupling devices H-I and J-K, which are placed in such a way that the activated coupling device H connects the idler gear 14, the activated coupling device I connects the idler gear 15, the activated coupling device J connects the idler gear 16 and the activated coupling device K connects the idler gear 17 each firmly with the second countershaft w_v2.

In the 5th and 12th variant embodiment according to FIGS. 9 and 23 there are provided on the first countershaft w_v1 a dual action coupling device B-C or D-E and a single action coupling device B or D, which are placed in such a way that the activated coupling device B connects the idler gear 8, the activated coupling device C connects the idler gear 9, the activated coupling device D connects the idler gear 10 and the activated coupling device E connects E the idler gear 11 each firmly with the first countershaft w_v1. On the second countershaft w_v2 there are provided two dual action coupling devices H-I and J-K as well one single action coupling device G or L, which are placed in such a way that the activated coupling device G connects the idler gear 13, the activated coupling device H connects the idler gear 14, the activated coupling device I connects the idler gear 15, the activated coupling device J connects the idler gear 16, the activated coupling device K connects the idler gear 17 and the activated coupling device L connects the idler gear 18 each firmly with the second countershaft w_v2.

In the 6th, 9th and 15th variant embodiments according to FIGS. 11, 17 and 29 there are provided on the first countershaft w_v1 a dual action coupling device B-C or D-E as well as two single action coupling devices A and C or E and F, which are placed in such a way that the activated coupling device A connects the idler gear 7, the activated coupling device B connects the idler gear 8, the activated coupling device C connects the idler gear 9, the activated coupling device D connects the idler gear 10, the activated coupling device E connects the idler gear 11 and the activated coupling device F connects the idler gear 12 each firmly with the first countershaft w_v1. On the second countershaft there are provided two dual action coupling devices H-I and J-K, which are placed in such a way, that the activated coupling device H connects the idler gear 14, the activated coupling device I connects the idler gear 15, the activated coupling device J connects the idler gear 16 and the activated coupling device K connects the idler gear 17 each firmly with the second countershaft w_v2.

In the 10th and 13th variant embodiments according to the FIGS. 19 and 25 there are provided on the first countershaft w_v1 three single action coupling devices A, C and D or B, E and F, which are placed in such a way that the activated coupling device A connects the idler gear 7, the activated coupling device B connects the idler gear 8, the activated coupling device C connects the idler gear 9, the activated coupling device D connects the idler gear 10, the activated coupling device E connects the idler gear 11 and the activated coupling device F connects the idler gear 12 each firmly with the first countershaft w_v1. On the second countershaft there are provided two dual action coupling devices H-I and J-K as well as one single action coupling devices G or L, which are placed in such a way that the activated coupling device G connects the idler gear 13, the activated coupling device H connects the idler gear 14, the activated coupling device I connects the idler gear 15, the activated coupling device J connects the idler gear 16, the activated coupling device K connects the idler gear 17 and the activated coupling device L connects the idler gear 18 each firmly with the second countershaft w_v2.

In the 11th and 14th variant embodiments according to FIGS. 21 and 27 there are provided on a first countershaft w_v1 a dual action coupling device D-E and a single action coupling device A or B, which are placed in such a way that the activated coupling device A connects the idler gear 7, the activated coupling device B connects the idler gear 8, the activated coupling device D connects the idler gear 10 and the activated coupling device E connects the idler gear 11 each firmly with the first countershaft w_v1. On the second countershaft there are provided two dual action coupling device H-I and J-K as well as one single action coupling device G or L, which are placed in such a way that the activated coupling device G connects the idler gear 13, the activated coupling device H connects the idler gear 14, the activated coupling device I connects the idler gear 15, the activated coupling device J connects the idler gear 16, the activated coupling device K connects the idler gear 17 and the activated coupling device L connects the idler gear 18 each firmly with the second countershaft w_v2.

Independent of the respective variant embodiments, there is provided in the double clutch transmission of the invention an integrated output stage with the output gear wheel 20 and with output gear wheel 21. The output gear wheel 20 and the output gear wheel 21 each mesh with a fixed gear 19 of the output shaft w_ab. Optionally, shiftable connections can be realized between the output gear wheels 20, 21 on the one hand and the allocated countershafts w_v1, w_v2 on the other hand through shiftable coupling devices S_ab1, S_ab2.

Moreover, it follows from the double clutch transmission of the invention that at least the countershafts G1 through G8 can be made as power shiftable. Depending on the variant embodiment, at least one reverse gear and/or crawler gears and/or an overdrive gear can additionally be made, e.g. also as power shiftable winding path gears. Details for each variant embodiment can be seen in the shift pattern described hereinafter.

The table represented in FIG. 2 is an example of a shift pattern for the 1st variant embodiment of the 8-speed double clutch transmissions according to FIG. 1.

The shift pattern shows that the first forward gear G1 can be shifted via the first clutch K1, via the activated coupling device F and via the activated shift element M as a winding path gear, that the second forward gear G2 can be shifted via the second clutch K2 and via the activated coupling device F, that the third forward gear G3 can be shifted via the first clutch K1 and via the activated coupling device C, that the fourth forward gear G4 can be shifted via the second clutch K2 and via the activated coupling device B, that the fifth forward gear G5 can be shifted via the first clutch K1 and via the activated coupling device H, that the sixth forward gear G6 can be shifted via the second clutch K2 and via the activated coupling device E, that the seventh gear G7 can be shifted via the first clutch K1 and via the activated coupling device D, and that the eighth forward gear G8 can be shifted via the second K2 and via the activated coupling device A. Thus, at least the first eight forward gears can be power shift gears (Isb.).

In addition, for example, a reverse gear R1 can be shifted via the first clutch K1 and via the activated coupling device G. A reverse gear R2 can be shifted via the second clutch K2, via the activated coupling device B, via the activated coupling device D and via the activated coupling device G as well as during disengaged coupling device S_ab1 as a winding path gear. Moreover, a reverse gear R3 can be shifted via the first clutch K1, via the activated coupling device B, via the activated coupling device E and via the activated coupling device G as well as a disengaged coupling device S_ab2 as a winding path gear.

Moreover, the shift pattern shows that a crawler gear C1 can be shifted via the second clutch K2 as well as via the activated coupling device C, via the activated coupling device F and via the activated coupling device H as well as a disengaged winding path gear gear-coupling device S_ab2 as a winding path gear. A crawler gear C2 can be shifted via the first clutch K1 as well as via the activated coupling device A, via the activated coupling device C and via the activated coupling device F as well as a disengaged winding path gear-coupling device S_ab1 as a winding path gear.

Finally, an overdrive gear O1 can be shifted via the second clutch K2 and via the activated coupling device D as well as via the activated shift element M as a winding path gear. An overdrive gear O2 can be shifted via the second clutch K2, via the activated coupling device A, via the activated coupling device C and via the activated coupling device H as well as a disengaged winding path gear-coupling device S_ab1 as a winding path gear. Moreover, an overdrive gear O3 can be shifted via the first clutch K1, via the activated coupling device B, via the activated coupling device D and via the activated coupling device E as well as a disengaged winding path gear-coupling device S_ab1 as a winding path gear. An overdrive gear O4 can be can be shifted via the first clutch K1, via the activated coupling device A, via the activated coupling device F and via the activated coupling device H as well as a disengaged winding path gear-coupling device S_ab2 as a winding path gear. Advantageously, the overdrive gear O4 can be designed as power shiftable to the eighth forward gear G8.

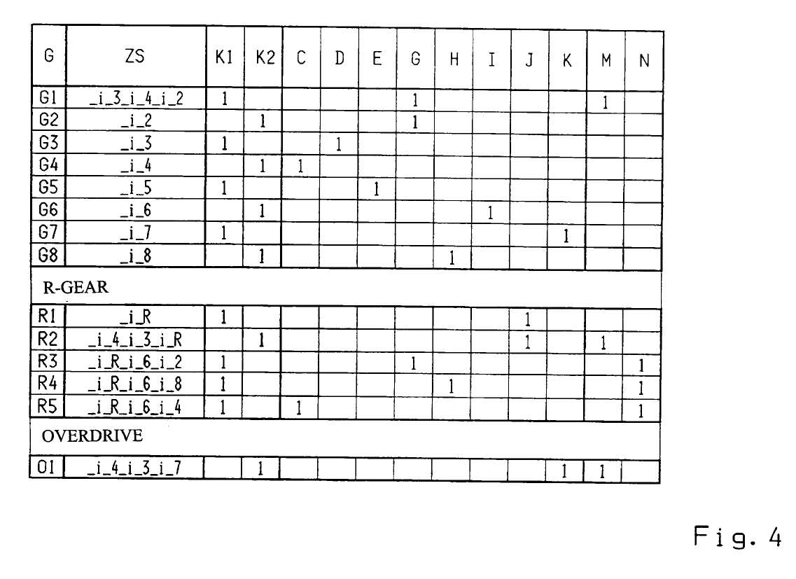

The table represented in FIG. 4 is an example of a shift pattern for the 2nd variant embodiment of the 8-speed double clutch transmissions according to FIG. 3.

The shift pattern shows that the first forward gear G1 can be shifted via the first clutch K1, via the activated coupling device G and via the activated shift element M as a winding path gear, that the second forward gear G2 via the second clutch K2 and via the activated coupling device G, that the third forward gear G3 is shiftable via the first clutch K1 and via the activated coupling device D, the fourth forward gear G4 can be shifted via the second clutch K2 and via the activated coupling device C, that the fifth forward gear G5 can be shifted via the first clutch K1 and via the activated coupling device E, that the sixth forward gear G6 can be shifted via the second clutch K2 and via the activated coupling device I, that the seventh forward gear G7 can be sifted via the first clutch K1 and via the activated coupling device K, and that the eighth forward gear G8 can be shifted via the second clutch K2 and via the activated coupling device H. Thus, at least the first eight forward gears can be made as power shiftable (Isb.).

In addition, for example a reverse gear R1 can be shifted via the first clutch K1 and via the activated coupling device J. A reverse gear R2 can be shifted via the second clutch K2 and via the activated coupling device J as well as via the activated shift element M as a winding path gear. Moreover, a reverse gear R3 can be shifted via the first clutch K1 and via the activated coupling device G as well as via an activated shift element N as a winding path gear. A reverse gear R4 can be shifted via the first clutch K1 and via the activated coupling device H as well as via an activated shift element N as a winding path gear. A reverse gear R5 can be shifted via the first clutch K1 and via the activated coupling device C as well as via an activated shift element N as a winding path gear.

Finally, also an overdrive gear O1 can be shifted via the second clutch K2 and via the activated coupling device K as well as via the activated shift element M as a winding path gear.

The table represented in FIG. 6 shows as an example of a shift pattern for the 3rd variant embodiment of the 8-speed-double clutch transmissions according to FIG. 5.

The shift pattern shows that the first forward gear G1 can be shifted via the first clutch K1, via the activated coupling device H and via the activated shift element M as a winding path gear, that the second forward gear G2 can be shifted via the second clutch K2 and via the activated coupling device H, that the third forward gear G3 can be shifted via the first clutch K1 and via the activated coupling device D, that the fourth forward gear G4 can be shifted via the second clutch K2 and via the activated coupling device C, that the fifth forward gear G5 can be shifted via the first clutch K1 and via the activated coupling device J, that the sixth forward gear G6 can be shifted via the second clutch K2 and via the activated coupling device A, that the seventh forward gear G7 can be shifted via the first clutch K1 and via the activated coupling device E, and that the eighth forward gear G8 can be shifted via the second clutch K2 and via the activated coupling device I. Thus, at least the first eight forward gears can be made as power shiftable (Isb.).

Moreover, for example, a reverse gear R1 can be shifted via the second clutch K2 and via the activated coupling device B. A reverse gear R2 can be shifted via the first clutch K1 and via the activated coupling device B as well as via the activated shift element M as a winding path gear. Moreover, a reverse gear R3 can be shifted via the first clutch K1 and via the activated coupling device B as well as via an activated shift element N as a winding path gear.

Moreover, in the 3rd variant embodiment, a crawler gear C1 can be shifted via the first clutch K1 and via the activated coupling device H as well as via an activated shift element N as a winding path gear.

Finally, also an overdrive gear O1 can be shifted via the second clutch K2 and via the activated coupling device E as well as via the activated shift element M as a winding path gear and/or an overdrive gear O2 via the second clutch K2 and via the activated coupling device E as well as via an activated shift element N as a winding path gear.

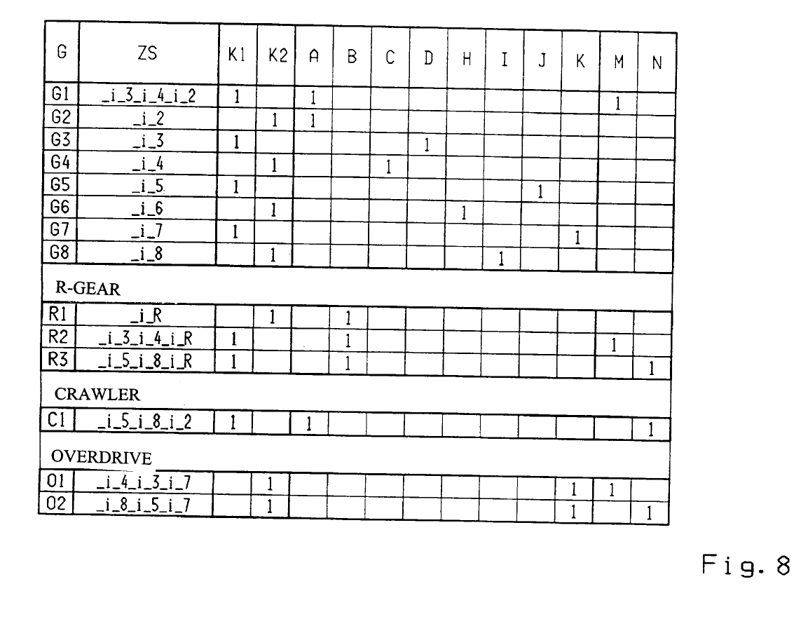

The table represented in FIG. 8 shows as example a shift pattern for 4th variant embodiment of the 8-speed-double clutch transmissions according to FIG. 7.

It follows from the shift pattern that the first forward gear G1 can be shifted via the first clutch K1 and via the activated coupling device A as well as via the activated shift element M as a winding path gear, that the second forward gear G2 can be shifted via the second clutch K2 and via the activated coupling device, that the third forward gear G3 can be shifted via the first clutch K1 and via the activated coupling device D, that the fourth forward gear G4 can be shifted via the second clutch K2 and via the activated coupling device C, that the fifth forward gear G5 can be shifted via the first clutch K1 and via the activated coupling device J, that the sixth forward gear G6 can be shifted via the second clutch K2 and via the activated coupling device H, and that the seventh forward gear G7 can be shifted via the first clutch K1 and via the activated coupling device K, and that the eighth forward gear G8 can be shifted via the second clutch K2 via the activated coupling device I. Thus, at least the first eight forward gears can be made as power shiftable.

In addition, in the 4th variant embodiment a reverse gear R1 can be shifted via the second clutch K2 and via the activated coupling device B and/or a reverse gear R2 via the first clutch K1 and via the activated coupling device B as well as via the activated shift element M as a winding path gear and/or a reverse gear R3 via the first clutch K1 and via the activated coupling device B as well as via an activated shift element N as a winding path gear.

A crawler gear C1 can be shifted via the first clutch K1 and via the activated coupling device A as well as via an activated shift element N as a winding path gear.

Finally, also an overdrive gear O1 can be shifted via the second clutch K2 and via the activated coupling device K as well as via the activated shift element M as a winding path gear and/or an overdrive gear O2 via the second clutch K2 and via the activated coupling device K as well as via an activated shift element N as a winding path gear.

The table represented in FIG. 10 shows an example of a shift pattern for the 5^{th} variant embodiment of the 8-speed double clutch transmissions according to FIG. 9.

It follows from the shift pattern that the first forward gear G1 can be shifted via the first clutch K1 and via the activated coupling device G as well as via the activated shift element M as a winding path gear, that the second forward gear G2 can be shifted via the second clutch K2 and via the activated coupling device G, that the third forward gear G3 can be shifted via the first clutch K1 and via the activated coupling device D, that the fourth forward gear G4 can be shifted via the second clutch K2 and via the activated coupling device C, that the fifth forward gear G5 can be shifted via the first clutch K1 and via the activated coupling device J, that the sixth forward gear G6 can be shifted via the second clutch K2 and via the activated coupling device H, that the seventh forward gear G7 can be shifted via the first clutch K1 and via the activated coupling device K, and that the eighth forward gear G8 can be shifted via the second clutch K2 and via the activated coupling device I. Thus, at least the first eight forward gears can be made as power shiftable.

In addition, in the 5th variant embodiment a reverse gear R1 can be made shiftable via the second clutch K2 and via the activated coupling device B and/or a reverse gear R2 via the first clutch K1 and via the activated coupling device B as well as via the activated shift element M as a winding path gear and/or a reverse gear R3 via the first clutch K1 and via the activated coupling device B as well as via an activated shift element N as a winding path gear.

Also a crawler gear C1 can be shifted via the first clutch K1 and via the activated coupling device G as well as via an activated shift element N as turn.

Finally, an overdrive gear O1 can be shifted via the second clutch K2 and via the activated coupling device K as well as via the activated shift element M as a winding path gear and/or an overdrive gear O2 via the second clutch K2 and via the activated coupling device K as well as via an activated shift element N as a winding path gear.

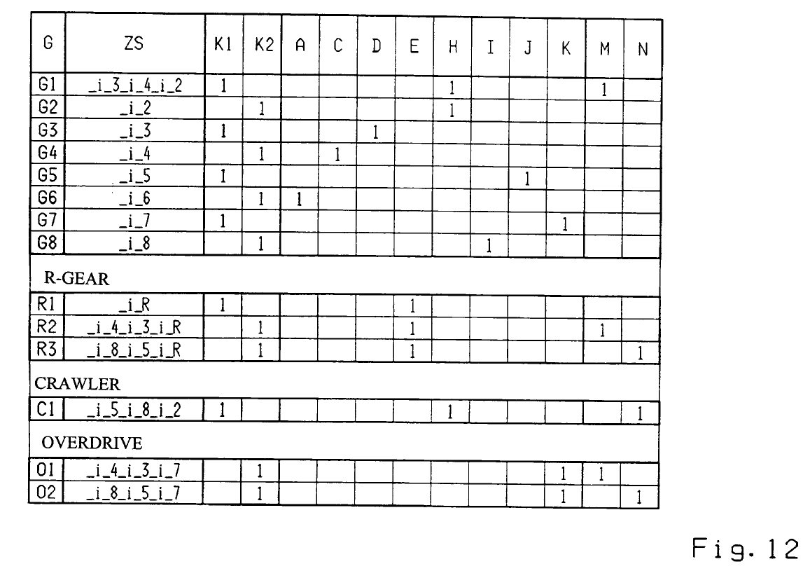

The table represented in FIG. 12 shows an example of a shift pattern for the 6th variant embodiment of the 8-speed double clutch transmissions according to FIG. 11.

It follows from the shift pattern that the first forward gear G1 can be shifted via the first clutch K1 and via the activated coupling device H as well as via the activated shift element M as a winding path gear, that the second forward gear G2 can be shifted via the second clutch K2 and via the activated coupling device H, that the third forward gear G3 can be shifted via the first clutch K1 and via the activated coupling device D, that the fourth forward gear G4 can be shifted via the second clutch K2 and via the activated coupling device C, that the fifth forward gear G5 can be shifted via the first clutch K1 and via the activated coupling device J, that the sixth forward gear G6 can be shifted via the second clutch K2 and via the activated coupling device A, that the seventh forward gear G7 can be shifted via the first clutch K1 and via the activated coupling device K, and that the eighth forward gear G8 can be shifted via the second clutch K2 and via the activated coupling device I. Thus, at least the first eight forward gears can be made as power shiftable.

Moreover, in the 6th variant embodiment a reverse gear R1 can be shifted via the first clutch K1 and via the activated coupling device E and/or a reverse gear R2 via the second clutch K2 and via the activated coupling device E as well as via the activated shift element M as a winding path gear and/or a reverse gear R3 via the second clutch K2 and via the activated coupling device E as well as via an activated shift element N as a winding path gear.

Also a crawler gear C1 can be shifted via the first clutch K1 and via the activated coupling device H as well as via an activated shift element N as a winding path gear.

Finally, an overdrive gear O1 can be shifted via the second clutch K2 and via the activated coupling device K as well as via the activated shift element M as a winding path gear and/or an overdrive gear O2 via the second clutch K2 and via the activated coupling device K as well as via an activated shift element N as a winding path gear.

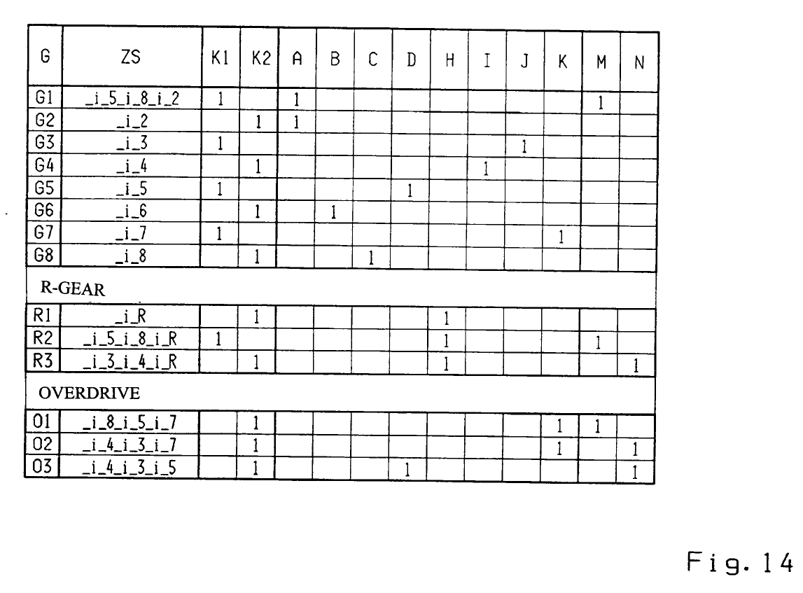

The table presented in FIG. 14 is an example of a shift pattern for the 7th variant embodiment of the 8-speed double clutch transmissions according to FIG. 13.

It follows from the shift pattern that the first forward gear G1 can be shifted via the first clutch K1 and via the activated coupling device A as well as via the activated shift element M as a winding path gear, that the second forward gear G2 can be shifted via the second clutch K2 and via the activated coupling device A, that the third forward gear G3 can be shifted via the first clutch K1 and via the activated coupling device J, that the fourth forward gear G4 can be shifted via the second clutch K2 and via the activated coupling device I, that the fifth forward gear G5 can be shifted via the first clutch K1 and via the activated coupling device D, that the sixth forward gear G6 can be shifted via the second clutch K2 and via the activated coupling device B, that the seventh forward gear G7 can be shifted via the first clutch K1 and via the activated coupling device K, and that the eighth forward gear G8 can be shifted via the second clutch K2 and via the activated coupling device C. Thus, at least the first eight forward gears forward gears can be made as power shiftable.

Moreover, in the 7th variant embodiment a reverse gear R1 can be shifted via the second clutch K2 and via the activated coupling device H and/or a reverse gear R2 can be shifted via the first clutch K1 and via the activated coupling device H as well as via the activated shift element M as a winding path gear and/or a reverse gear R3 can be shifted via the second clutch K2 and via the activated coupling device H as well as via an activated shift element N as a winding path gear.

Finally, an overdrive gear O1 can be shifted via the second clutch K2 and via the activated coupling device K as well as via the activated shift element M as a winding path gear and/or an overdrive gear O2 can be shifted via the second clutch K2 and via the activated coupling device K as well as via an activated shift element N as a winding path gear and/or an overdrive gear O3 can be shifted via the second clutch K2 and via the activated coupling device D as well as via an activated shift element N as a winding path gear.

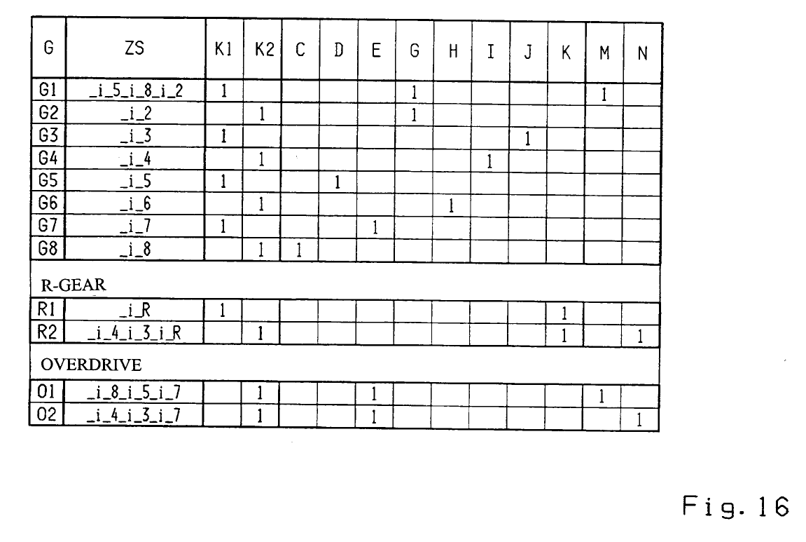

The table presented in FIG. 16 shows an example of a shift pattern for the 8th variant embodiment of the 8-speed double clutch transmissions according to FIG. 15.

It follows from the shift pattern that the first forward gear G1 can be shifted via the first clutch K1 and via the activated coupling device G as well as via the activated shift element M as a winding path gear, that the second forward gear G2 can be shifted via the second clutch K2 and via the activated coupling device G, that the third forward gear G3 can be shifted via the first clutch K1 and via the activated coupling device J, that the fourth forward gear G4 can be shifted via the second clutch K2 and via the activated coupling device I, that the fifth forward gear G5 via the first clutch K1 and via the activated coupling device D, that the sixth forward gear G6 can be shifted via the second clutch K2 and via the activated coupling device H, that the seventh forward gear G7 can be shifted via the first clutch K1 and via the activated coupling device E, and that the eighth forward gear G8 can be shifted via the second clutch K2 and via the activated coupling device C. Thus, at least the first eight forward gears can be made as power shiftable.

Moreover, in the 8th variant embodiment a reverse gear R1 can be shifted via the first clutch K1 and via the activated coupling device K and/or a reverse gear R2 can be shifted via the second clutch K2 and via the activated coupling device K as well as via an activated shift element N as a winding path gear.

Finally, an overdrive gear O1 can be shifted via the second clutch K2 and via the activated coupling device E as well as via the activated shift element M as a winding path gear and/or an overdrive gear O2 can be shifted via the second clutch K2 and via the activated coupling device E as well as via an activated shift element N as a winding path gear.

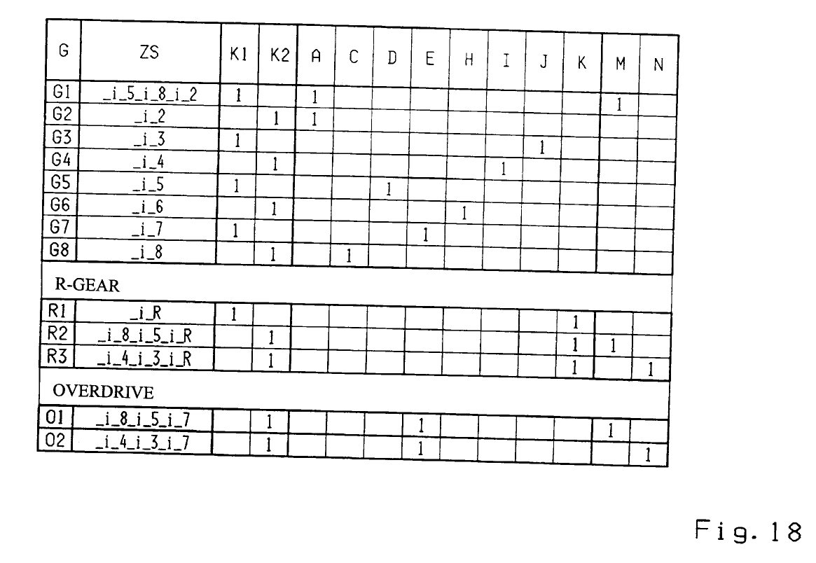

The table presented in FIG. 18 shows an example of a shift pattern for the 9th variant embodiment of the 8-speed double clutch transmissions according to FIG. 17.

It follows from the shift pattern that the first forward gear G1 can be shifted via the first clutch K1 and via the activated coupling device A as well as via the activated shift element M as a winding path gear, that the second forward gear G2 can be shifted via the second clutch K2 and via the activated coupling device A, that the third forward gear G3 can be shifted via the first clutch K1 and via the activated coupling device J, that the fourth forward gear G4 can be shifted via the second clutch K2 and via the activated coupling device I, that the fifth forward gear G5 can be shifted via the first clutch K1 and via the activated coupling device D, that the sixth forward gear G6 can be shifted via the second clutch K2 and via the activated coupling device H, that the seventh forward gear G7 can be shifted via the first clutch K1 and via the activated coupling device E, and that the eighth forward gear G8 can be shifted via the second clutch K2 and via the activated coupling device C. Thus, at least the first eight forward gears can be made as power shiftable.

Moreover, in the 9th variant embodiment a reverse gear R1 can be shifted via the first clutch K1 and via the activated coupling device K and/or a reverse gear R2 can be shifted via the second clutch K2 and via the activated coupling device K as well as via the activated shift element M as a winding path gear and/or a reverse gear R3 can be shifted via the second clutch K2 and via the activated coupling device K as well as via an activated shift element N as a winding path gear.

Finally, an overdrive gear O1 can be shifted via the second clutch K2 and via the activated coupling device E as well as via the activated shift element M as a winding path gear and/or an overdrive gear O2 can be shifted via the second clutch K2 and via the activated coupling device E as well as via an activated shift element N as a winding path gear.

The table shown in FIG. 20 shows an example of a shift pattern for the 10th variant embodiment of the 9-speed double clutch transmissions according to FIG. 19.

It follows from the shift pattern that the first forward gear G1 can be shifted via the first clutch K1 and via the activated coupling device A as well as via the activated shift element M as a winding path gear, that the second forward gear G2 can be shifted via the second clutch K2 and via the activated coupling device A, that the third forward gear G3 can be shifted via the first clutch K1 and via the activated coupling device J, that the fourth forward gear G4 can be shifted via the second clutch K2 and via the activated coupling device I, that the fifth forward gear G5 can be shifted via the first clutch K1 and via the activated coupling device D, that the sixth forward gear G6 can be shifted via the second clutch K2 and via the activated coupling device H, that the seventh forward gear G7 can be shifted via the first clutch K1 and via the activated coupling device K, and that the eighth forward gear G8 can be shifted via the second clutch K2 and via the activated coupling device C. Thus, at least the first eight forward gears can be made as power shiftable.

Moreover, in the 10th variant embodiment a reverse gear R1 can be shifted via the second clutch K2 and via the activated coupling device G and/or a reverse gear R2 can be shifted via the first clutch K1 and via the activated coupling device G as well as via the activated shift element M as a winding path gear and/or a reverse gear R3 via the first clutch K1 and via the activated coupling device G as well as via an activated shift element N as a winding path gear.

Finally, an overdrive gear O1 can be shifted via the second clutch K2 and via the activated coupling device K as well as via the activated shift element M as a winding path gear and/or an overdrive gear O2 can be shifted via the second clutch K2 and via the activated coupling device K as well as via an activated shift element N as a winding path gear.

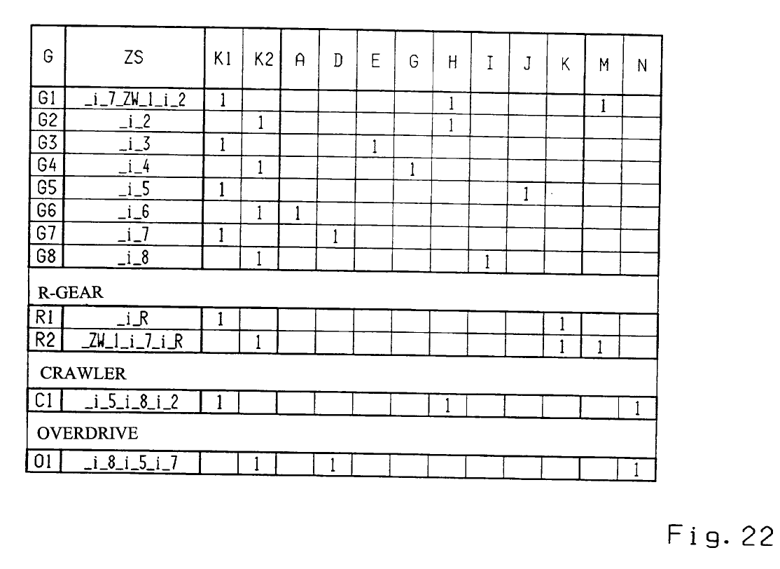

The table represented in FIG. 22 shows an example of a shift pattern for the 11th variant embodiment of the 8-speed double clutch transmissions according to FIG. 21.

It follows from the shift pattern that the first forward gear G1 can be shifted via the first clutch K1 and via the activated coupling device H as well as via the activated shift element M as a winding path gear, that the second forward gear G2 can be shifted via the second clutch K2 and via the activated coupling device H, that the third forward gear G3 can be shifted via the first clutch K1 and via the activated coupling device E, that the fourth forward gear G4 can be shifted via the second clutch K2 and via the activated coupling device G, that the fifth forward gear G5 can be shifted via the first clutch K1 and via the activated coupling device J, that the sixth forward gear G6 can be shifted via the second clutch K2 and via the activated coupling device A, that the seventh forward gear G7 can be shifted via the first clutch K1 and via the activated coupling device D, and that the eighth forward gear G8 can be shifted via the second clutch K2 and via the activated coupling device I. Thus, at least the first eight forward gears can be made as power shiftable.

Moreover, in the 11th variant embodiment a reverse gear R1 can be shifted via the first clutch K1 and via the activated coupling device K and/or a reverse gear R2 can be shifted via the second clutch K2 and via the activated coupling device K as well as via the activated shift element M as a winding path gear.

In addition thereto, a crawler gear C1 can be shifted via the first clutch K1 and via the activated coupling device H as well as via an activated shift element N as a winding path gear.

Finally, overdrive gear O1 can be shifted via the second clutch K2 and via the activated coupling device D as well as via an activated shift element N as a winding path gear.

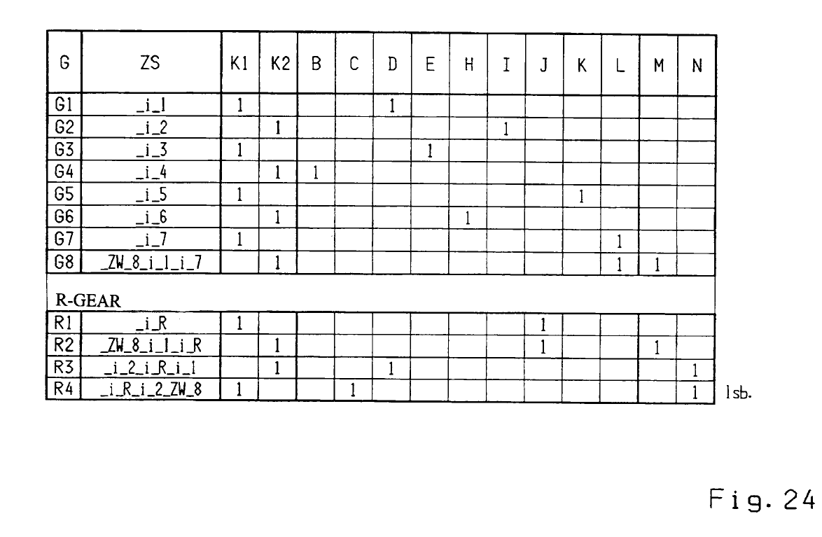

The table represented in FIG. 24 shows an example of a shift pattern for the 12th variant embodiment of the 8-speed double clutch transmissions according to FIG. 23.

It follows from the shift pattern that the first forward gear G1 can be shifted via the first clutch K1 and via the activated coupling device D, that the second forward gear G2 can be shifted via the second clutch K2 and via the activated coupling device I, that the third forward gear G3 can be shifted via the first clutch K1 and via the activated coupling device E, that the fourth forward gear G4 can be shifted via the second clutch K2 and via the activated coupling device B, that the fifth forward gear G5 can be shifted via the first clutch K1 and via the activated coupling device K, that the sixth forward gear G6 can be shifted via the second clutch K2 and via the activated coupling device H, that the seventh forward gear G7 can be shifted via the first clutch K1 and via the activated coupling device L, and that the eighth forward gear G8 can be shifted via the second clutch K2 and via the activated coupling device L as well as via the activated shift element M as a winding path gear. Thus, at least the first eight forward gears can be made as power shiftable.

Moreover, in the 12th variant embodiment a reverse gear R1 can be shifted via the first clutch K1 and via the activated coupling device J and/or a reverse gear R2 can be shifted via the second clutch K2 and via the activated coupling device J as well as via the activated shift element M as a winding path gear and/or a reverse gear R3 can be shifted via the second clutch K2 and via the activated coupling device D as well as via an activated shift element N as a winding path gear and/or a reverse gear R4 via the first clutch K1 and via the activated coupling device C as well as via an activated shift element N as a winding path gear. Advantageously, the reverse gear R3 can be made as power shiftable to the first forward gear G1.

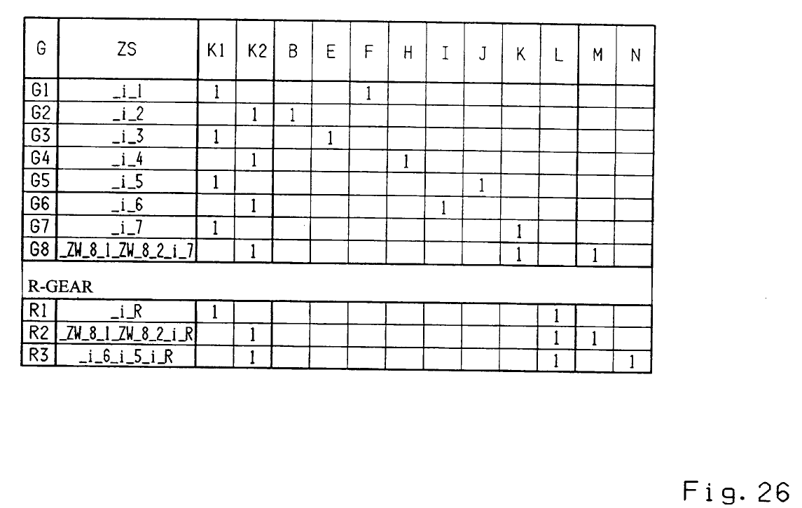

The table represented in FIG. 26 shows an example of a shift pattern for the 13th variant embodiment of the 8-speed double clutch transmissions according to FIG. 25.

It follows from the shift pattern that the first forward gear G1 can be shifted via the first clutch K1 and via the activated coupling device F, that the second forward gear G2 can be shifted via the second clutch K2 and via the activated coupling device B, that the third forward gear G3 can be shifted via the first clutch K1 and via the activated coupling device E, that the fourth forward gear G4 can be shifted via the second clutch K2 and via the activated coupling device H, that the fifth forward gear G5 can be shifted via the first clutch K1 and via the activated coupling device J, that the sixth forward gear G6 can be shifted via the second clutch K2 and via the activated coupling device I, that the seventh forward gear G7 can be shifted via the first clutch K1 and via the activated coupling device K, and that the eighth forward gear G8 can be shifted via the second clutch K2 and via the activated coupling device K as well as via the activated shift element M as a winding path gear. Thus, at least the first eight forward gears can be made as power shiftable.

Moreover, in the 13th variant embodiment a reverse gear R1 can be shifted via the first clutch K1 and via the activated coupling device L and/or a reverse gear R2 can be shifted via the second clutch K2 and via the activated coupling device L as well as via the activated shift element M as a winding path gear and/or a reverse gear R3 can be shifted via the second clutch K2 and via the activated coupling device L as well as via an activated shift element N as a winding path gear.

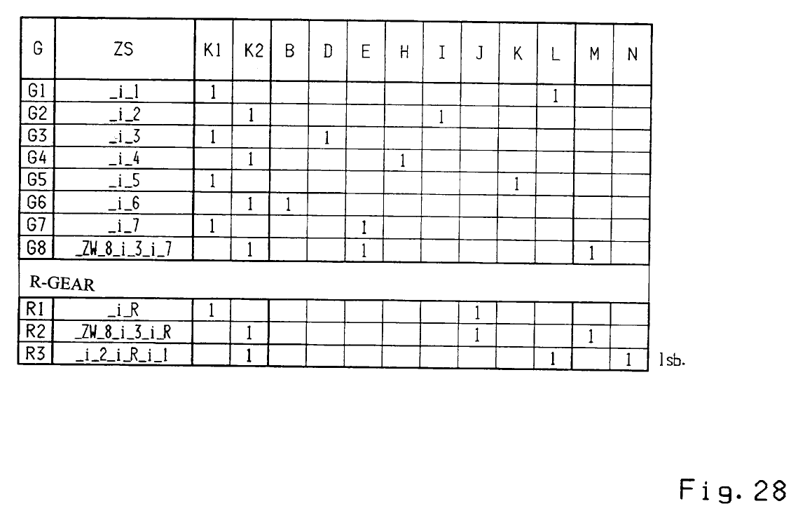

The table represented in FIG. 28 shows an example of a shift pattern for the 14th variant embodiment of the 8-speed double clutch transmissions according to FIG. 27.

It follows from the shift pattern that the first forward gear G1 can be shifted via the first clutch K1 and via the activated coupling device L, that the second forward gear G2 can be shifted via the second clutch K2 and via the activated coupling device I, that the third forward gear G3 can be shifted via the first clutch K1 and via the activated coupling device D, that the fourth forward gear G4 can be shifted via the second clutch K2 and via the activated coupling device H, that the fifth forward gear G5 can be shifted via the first clutch K1 and via the activated coupling device K, that the sixth forward gear G6 can be shifted via the second clutch K2 and via the activated coupling device B, that the seventh forward gear G7 can be shifted via the first clutch K1 and via the activated coupling device E, and that the eighth forward gear G8 can be shifted via the second clutch K2 and via the activated coupling device E as well as via the activated shift element M as a winding path gear. Thus, at least the first eight forward gears can be made as power shiftable.

Moreover, in the 14th variant embodiment a reverse gear R1 can be shifted via the first clutch K1 and via the activated coupling device J and/or a reverse gear R2 can be shifted via the second clutch K2 and via the activated coupling device J as well as via the activated shift element M as a winding path gear and/or a reverse gear R3 can be shifted via the second clutch K2 and via the activated coupling device L as well as via an activated shift element N as a winding path gear. Advantageously, the reverse gear R3 is as power shiftable to the first forward gear G1.

The table represented in FIG. 30 shows an example of a shift pattern for the 15th variant embodiment of the 8-speed double clutch transmissions according to FIG. 29.

It follows from the shift pattern that the first forward gear G1 can be shifted via the first clutch K1 and via the activated coupling device J, that the second forward gear G2 can be shifted via the second clutch K2 and via the activated coupling device C, that the third forward gear G3 can be shifted via the first clutch K1 and via the activated coupling device K, that the fourth forward gear G4 can be shifted via the second clutch K2 and via the activated coupling device H, that the fifth forward gear G5 can be shifted via the first clutch K1 and via the activated coupling device E, that the sixth forward gear G6 can be shifted via the second clutch K2 and via the activated coupling device B, that the seventh forward gear G7 can be shifted via the first clutch K1 and via the activated coupling device F, and that the eighth forward gear G8 can be shifted via the second clutch K2 and via the activated coupling device F as well as via the activated shift element M as a winding path gear. Thus, at least the first eight forward gears can be made as power shiftable.

Moreover, in the 15th variant embodiment a reverse gear R1 can be shifted via the second clutch K2 and via the activated coupling device I and/or a reverse gear R2 can be shifted via the first clutch K1 and via the activated coupling device I as well as via the activated shift element M and/or a reverse gear R3 can be shifted via the second clutch K2 and via the activated coupling device D as well as via a activated shift element N as a winding path gear and/or a reverse gear R4 can be shifted via the first clutch K1 and via the activated coupling device C as well as via an activated shift element N as a winding path gear.

It follows from the shift pattern of the 1st through 6th variant embodiments according to FIGS. 1 through 12 in particular that in the first forward gear G1, starting with the first clutch K1, gear stage i_3, i_4 and i_2 will be used, while the two subtransmissions are coupled via the activated shift element M. In the second forward gear G2, the gear stage i_2 will be used, in the third forward gear G3, the gear stage i_3 will be used, in the fourth forward gear G4, the gear stage i_4 will be used, in the fifth forward gear G5, the gear stage i_5 will be used, in the sixth forward gear G6, the gear stage i_6 will be used, in the seventh forward gear G7, the gear stage i_7 will be used and in the eighth forward gear G8, the gear stage i_8 will be used.

In the shift pattern of the 1st variant embodiment according to FIG. 2 in the reverse gear R1 starting from the first clutch K1, the gear stage i_R will also be used. In addition thereto in the additional reverse gear R2, starting from the second clutch K2, the gear stage i_4, i_7 and i_R will be used, while for the coupling of the two subtransmissions a winding path gear-coupling device S_ab1 will be disengaged. In the reverse gear R3, starting from the first clutch K1, the gear stage i_R, i_6 and i_4 will be used, while the two subtransmissions will be coupled with a disengaged coupling device S_ab2.

For the crawler gear C1, starting from the second clutch K2, the gear stage i_2, i_5 and i_3 will be used, while the two subtransmissions will be coupled with a disengaged winding path gear-coupling device S_ab2. For the crawler gear C2, starting from the first clutch K1, the gear stage i_3, i_8 and i_2 will be used, while the two subtransmissions will be coupled with a disengaged coupling device S_ab1.

For overdrive gear O1, starting from the second clutch K2, the gear stage i_4, i_3 and i_7 will be used, while the two subtransmissions will be coupled via the activated shift element M. For overdrive gear O2, starting from the second clutch K2, the gear stage i_8, i_3 and i_5 will be used, while the two subtransmissions will be coupled with a disengaged winding path gear-coupling device S_ab1. For overdrive gear O3, starting from the first clutch K1, the gear stage i_7, i_4 and i_6 will be used, while the two subtransmissions will be coupled with a disengaged coupling device S_ab1. For overdrive gear O4, starting from the first clutch K1, the gear stage i_5, i_2 and i_8 will be used, while the two subtransmissions will be coupled with a disengaged coupling device S_ab2.

In addition, it follows from the shift pattern according to FIG. 4 that for the reverse gear R1, starting from the first clutch K1, the gear stage i_R will be used. In addition thereto for the additional reverse gear R2 starting from the second clutch K2, the gear stage i_4, i_3 and i_R will be used, while for coupling the two subtransmissions, the shift element M will be activated. For the reverse gear R3, starting from the first clutch K1 the gear stage i_R, i_6 and i_2 will be used, while the coupling of the two subtransmissions will occur via activated shift element N. For reverse gear R4, starting from the first clutch K1, the gear stage i_R, i_6 and i_8 will be used, while the coupling of the two subtransmissions will occur via activated shift element N. For reverse gear R5, starting from the first clutch K1, the gear stage i_R, i_6 and i_4 will be used, while the coupling of the two subtransmissions will occur via activated shift element N. For overdrive gear O1, starting from the second clutch K2, the gear stage i_4, i_3 and i_7 will be used, while the coupling of the two subtransmissions will occur via activated shift element M.

In addition, it follows from the shift pattern according to FIGS. 6, 8 and 10, that for the reverse gear R1, starting from the second clutch K2, the gear stage i_R will be used. In addition thereto for the additional reverse gear R2, starting from the first clutch K1, the gear stage i_3, i_4 and i_R will be used, while for the coupling of the two subtransmissions the shift element M will be activated. For reverse gear R3, starting from the first clutch K1, the gear stage i_5, i_8 and i_R will be used, while the coupling of the two subtransmissions will occur via activated shift element. In addition thereto for the crawler gear C1, starting from the first clutch K1, the gear stage i_5, i_8 and i_2 will be used, while the coupling of the two subtransmissions will occur via the activated shift element N. Moreover, for the overdrive gear O1, starting from the second clutch K2, the gear stage i_4, i_3 and i_7 will be used, while the coupling of the two subtransmissions with one another will occur via the activated shift element M. Finally, for the overdrive gear O2, starting from the second clutch K2, the gear stage i_8, i_5 and i_7 will be used, while the coupling of the two subtransmissions will occur via the activated shift element N.

Unlike the shift patterns of FIGS. 6, 8 and 10, it follows from the shift pattern according to FIG. 12 that the reverse gear R1 will be shifted differently via the first clutch K1 as well as the reverse gears R2 and R3 each via the second clutch K2.

It follows from the shift pattern of the 7th through 10th variant embodiments according to FIGS. 13 through 20 in particular, that for the first forward gear G1, starting from the first clutch K1m the gear stage i_5, i_8 and i_2 will be used, while the coupling of the two subtransmissions will occur via the activated shift element M. For the second forward gear G2, the gear stage i_2 will be used, for the third forward gear G3, the gear stage i_3 will be used, for the fourth forward gear G4, the gear stage i_4 will be used, for the fifth forward gear G5, the gear stage i_5 will be used, for the sixth forward gear G6, the gear stage i_6 will be used, for the seventh forward gear G7, the gear stage i_7 will be used, and for the eighth forward gear G8, the gear stage i_8 will be used.

It follows also from the shift pattern according to FIG. 14 that for the reverse gear R1, starting from the second clutch K2, the gear stage i_R will be used. In addition thereto, for the additional reverse gear R2, starting from the first clutch K1, the gear stage i_5, i_8 and i_R will be used, while for the coupling of the two subtransmissions the shift element M will be activated. For the reverse gear R3, starting from the second clutch K2, the gear stage i_3, i_4 and i_R will be used, while the coupling of the two subtransmissions will occur during activated shift element N. For overdrive gear O1, starting from the second clutch K2, the gear stage i_8, i_5 and i_7 will be used, while the coupling of the two subtransmissions will occur via the activated shift element M. For overdrive gear O2, starting from the second clutch K2, the gear stage i_4, i_3 and i_7 will be used, while the coupling of the two subtransmissions will occur via the activated shift element N. For overdrive gear O3, starting from the second clutch K2, the gear stage i_4, i_3 and i_5 will be used, while the coupling of the two subtransmissions will occur via the activated shift element N.

It follows also from the shift pattern according to FIG. 16 that the reverse gear R1, starting from the first clutch K1, the gear stage i_R will be used. In addition thereto for the additional reverse gear R2, starting from the second clutch K2, the gear stage i_4, i_3 and i_R will be used, while for the coupling of the two subtransmissions the shift element N will be activated. For the overdrive gear O1, starting from the second clutch K2, the gear stage i_8, i_5 and i_7 will be used, while the two transmissions will be coupled via the activated shift element M. For the overdrive gear O2, starting from the second clutch K2, the gear stage i_4, i_3 and i_7 will be used, while the two subtransmissions will be coupled via the activated shift element N.

It follows from the shift pattern according to FIG. 18, that for the reverse gear R1 starting from the first clutch K1 the gear stage i_R will be used. In addition thereto for the other reverse gear R2, starting from the second clutch K2, the gear stage i_8, i_5 and i_R will be used, while for the coupling of the two subtransmissions the shift element M will be activated. For reverse gear R3, starting from the second clutch K2, the gear stage i_4, i_3 and i_R will be used, while the two subtransmissions will be coupled during activated shift element N. For overdrive gear O1, starting from the second clutch K2, the gear stage i_8, i_5 and i_7 will be used, while the two subtransmissions will be coupled via the activated shift element M. For overdrive gear O2, starting from the second clutch K2, the gear stage i_4, i_3 and i_7 will be used, while the two subtransmissions will be coupled via the activated shift element N.

It follows also from the shift pattern according to FIG. 20 that for reverse gear R1, starting from the second clutch K2, the gear stage i_R will be used. In addition thereto for the additional reverse gear R2, starting from the first clutch K1, the gear stage i_5, i_8 and i_R will be used, while for the coupling of the two subtransmissions the shift element M will be activated. For reverse gear R3, starting from the second clutch K1, the gear stage i_3, i_4 and i_R will be used, while the two subtransmissions will be coupled during activated shift element N. For overdrive gear O1, starting from the second clutch K2, the gear stage i_8, i_5 and i_7 will be used, while the two subtransmissions will be coupled via the activated shift element M. For overdrive gear O2, starting from the second clutch K2, the gear stage i_4, i_3 and i_7 will be used, while the two subtransmissions will be coupled via the activated shift element N.

It follows from the shift pattern according to the 11th variant embodiment according to FIG. 22 in particular that for the first forward gear G1, starting from the first clutch K1, the gear stage i_7, ZW_1 and i_2 will be used, while the two subtransmissions will be coupled with one another via the activated shift element M. For the second forward gear G2 the gear stage i_2 will be used, for the third forward gear G3 the gear stage i_3 will be used, for the fourth forward gear G4 the gear stage i_4 will be used, for the fifth forward gear G5 the gear stage i_5 will be used, for the sixth forward gear G6 the gear stage i_6 will be used, for the seventh forward gear G7 the gear stage i_7 will be used, and for the eighth forward gear G8 the gear stage i_8 will be used.

It follows also from the shift pattern according to FIG. 22 that for the reverse gear R1, starting from the first clutch K1, the gear stage i_R will be used. In addition thereto for the additional reverse gear R2, starting from the second clutch K2, the gear stage ZW_1, i_7 and i_R will be used, while for the coupling of the two subtransmissions the shift element M will be activated. For crawler gear C1, starting from the first clutch K1, the gear stage i_5, i_8 and i_2 will be used, while the two subtransmissions will be coupled with one another via the activated shift element N. For overdrive gear O1, starting from the second clutch K2, the gear stage i_8, i_5 and i_7 will be used, while the two subtransmissions will be coupled via the activated shift element N.

It follows from the shift pattern of the 12th variant embodiment according to FIG. 24 in particular that for the first forward gear G1 the gear stage i_1 will be used, for the second forward gear G2 the gear stage i_2 will be used, for the third forward gear G3 the gear stage i_3 will be used, for the fourth forward gear G4 the gear stage i_4 will be used, for the fifth forward gear G5 the gear stage i_5 will be used, for the sixth forward gear G6 the gear stage i_6 and for the seventh forward gear G7 the gear stage i_7 will be used. For the eighth forward gear G8, starting from the second clutch K2, the gear stage ZW_8, i_1 and i_7 will be used, while the two transmissions will be coupled with one another via the activated shift element M.

It follows also from the shift pattern according to FIG. 24 that for the reverse gear R1, starting from the first clutch K1, the gear stage i_R will be used. In addition thereto for the additional reverse gear R2, starting from the second clutch K2, the gear stage ZW_8, i_1 and i_R will be used, while for the coupling of the two subtransmissions the shift element M will be activated. For the reverse gear R3, starting from the second clutch K2, the gear stage i_2, i_R and i_1 will be used, while for the coupling of the two subtransmissions the shift element N will be activated. For the reverse gear R4, starting from the first clutch K1, the gear stage i_R, i_2 and ZW_8 will be used, while the two transmissions will be coupled with one another via the activated shift element N.

It follows from the shift pattern of the 13th variant embodiment according to FIG. 26 in particular that for the first forward gear G1 the gear stage i_1 will be used, for the second forward gear G2 the gear stage i_2 will be used, for the third forward gear G3 the gear stage i_3 will be used, for the fourth forward gear G4 the gear stage i_4 will be used, for the fifth forward gear G5 the gear stage i_5 will be used, for the sixth forward gear G6 the gear stage i_6 and for the seventh forward gear G7 the gear stage i_7 will be used. For the eighth forward gear G8, starting from the second clutch K2, the gear stage ZW_8_1, ZW_8_2 and i_7 will be used, while the two transmissions will be coupled via the activated shift element M.

It follows from the shift pattern according to FIG. 26 that for the reverse gear R1, starting from the first clutch K1, the gear stage i_R will be used. In addition thereto for the additional reverse gear R2, starting from the second clutch K2, the gear stage ZW_8_1, ZW_8_2 and i_R will be used, while for the coupling of the two subtransmissions the shift element M will be activated. For the reverse gear R3, starting from the second clutch K2, the gear stage i_6, i_5 and i_R will be used, while for the coupling of the two subtransmissions the shift element N will be activated.

It follows also from the shift pattern of the 14th variant embodiment according to FIG. 28 in particular that for the first forward gear G1, the gear stage i_1 will be used, for the second forward gear G2 the gear stage i_2 will be used, for the third forward gear G3 the gear stage i_3 will be used, for the fourth forward gear G4 the gear stage i_4 will be used, for the fifth forward gear G5 the gear stage i_5 will be used, for the sixth forward gear G6 the gear stage i_6 and for the seventh forward gear G7 the gear stage i_7 will be used. For the eighth forward gear G8, starting from the second clutch K2, the gear stage ZW_8, i_3 and i_7 will be used, while the two transmissions will be coupled with one another via the activated shift element M.

It follows also from the shift pattern according to FIG. 28 that for the reverse gear R1, starting from the first clutch K1, the gear stage i_R will be used. In addition thereto for the additional reverse gear R2, starting from the second clutch K2, the gear stage ZW_8, i_3 and i_R will be used, while for the coupling of the two subtransmissions the shift element M will be activated. For the reverse gear R3, starting from the second clutch K2, the gear stage i_2, i_R and i_1 will be used, while for the coupling of the two subtransmissions the shift element N will be activated.

It follows from the shift pattern of the 15th variant embodiment according to FIG. 30 in particular that for the first forward gear G1 the gear stage i_1 will be used, for the second forward gear G2 the gear stage i_2 will be used, for the third forward gear G3 the gear stage i_3 will be used, for the fourth forward gear G4 the gear stage i_4 will be used, for the fifth forward gear G5 the gear stage i_5 will be used, for the sixth forward gear G6 the gear stage i_6 and for the seventh forward gear G7 the gear stage i_7 will be used. For the eighth forward gear G8, starting from the second clutch K2, the gear stage i_2, ZW_8 and i_7 will be used, while the two transmissions will be coupled with one another via the activated shift element M.

It follows also from the shift pattern according to FIG. 30 that for the reverse gear R1, starting from the second clutch K2, the gear stage i_R will be used. In addition thereto for the additional reverse gear R2, starting from the first clutch K1, the gear stage ZW_8, i_2 and i_R will be used, while for the coupling of the two subtransmissions the shift element M will be activated. For the reverse gear R3, starting from the second clutch K2, the gear stage i_R, i_1 and ZW_8 will be used, while for the coupling of the two subtransmissions the shift element N will be activated. For the reverse gear R4, starting from the first clutch K1, the gear stage i_1, i_R and i_2 will be used, while the two transmissions will be coupled with one another via the activated shift element N.

In summary, it follows from the 1st thru 6th variant embodiments according to FIGS. 1 thru 12, that three dual gear planes and two single gear planes are provided. Moreover, the first forward gear can be shifted as a winding path gear via the gear stages of the third, fourth and second gears. In addition thereto there will result an overdrive gear that is power shiftable to the seventh forward gear, resulting in savings of fuel.

Thus, because the gear steps of the second and fourth gears are placed on single gear planes, a good adaptation of the lower gears can be achieved for the 1st variant embodiment. With the optional winding path gear-coupling device S_ab2 a power shiftable ninth forward gear as overdrive gear O4 can be realized. Thus, a power shiftable 9-stepped gear set will be created, for which at least the first nine gears are power shiftable.

It follows in particular from the 1st variant embodiment that in the first gear plane 8-12 designed as a dual gear plane, the idler gear 8 will be used for four forward gears G8, C2, O2, O4 and the idler gear 12 will be used for two forward gears G6, O3 as well as for one reverse gear R3. For the second gear plane 9-2 designed as a single gear plane, the idler gear 9 will be used for four forward gears G1, G4, O1, O3 as well as for two reverse gears R2, R3. For the third gear plane 3-13 designed as a single gear plane, the idler gear 13 for five forward gears G1, G2, C1, C2, O4 will be used. In the fourth gear plane 10-14 designed as a dual gear plane, the idler gear 10 will be used for six forward gears G1, G3, C1, C2, O1, O2 and the idler gear 14 for three reverse gears R1, R2, R3. For the fifth gear plane 11-15 designed as a dual gear plane, the idler gear 11 will be used for three forward gears G7, O1, O3 as well as for one reverse gear R2 and the idler gear 15 will be used for four forward gears G5, C1, O2, O4.

Advantageously, it follows for the 2nd variant embodiment that two reverse gears that are power shiftable to one another will be realized.

In particular it follows for the 2nd variant embodiment that for the first gear plane 1-13 designed as a single gear plane, the idler gear 13 will be used for two forward gears G1, G2 as well as for a reverse gear R3. For the second gear plane 2-14 designed as a single gear plane, the idler gear 14 will be used for one forward gear G8 as well as for one reverse gear R4. For the third gear plane 9-15 designed as a dual gear plane, the idler gear 9 will be used for three forward gears C1, G4, O1 as well as for two reverse gears R2, R5 and the idler gear 10 will be used for one forward gear G6 as well as for three reverse gears R3, R4, R5. For the fourth gear plane 10-16 designed as a dual gear plane, the idler gear 10 will be used for three forward gears G1, G3, O1 as well as for one reverse gear R2 and the idler gear 16 will be used for five reverse gears R1 thru R5. Finally, for the fifth gear plane 11-17 designed as a dual gear plane, the idler gear 11 will be used for one forward gear G5 and the idler gear 17 will be used for two forward gears G7, O1.

Because of the placement of the sixth and seventh gear step on single gear planes there will result a good stepping adaptation for the 3rd variant embodiment, particularly in the upper gears. In addition thereto two reverse gears that are power shiftable to one another will be realized.

In particular, it follows for the third variant embodiment that for the first gear plane 7-1 designed as a single gear plane, the idler gear 7 will be used for one forward gear G6. For the second gear plane 8-14 designed as a dual gear plane, the idler gear 8 will be used for three reverse gears R1 thru R3 and the idler gear 14 for three forward gears G1, G2, C1. For the third gear plane 9-15 designed as a dual gear plane, the idler gear 9 will be used for three forward gears G1, G4, O1 as well as for one reverse gear R2 and the idler gear 15 for three forward gears G8, C1, O2 as well as for one reverse gear R3. For the fourth gear plane 10-16 designed as a dual gear plane, the idler gear 10 will be used for three forward gears G1, G3, O1 as well as for one reverse gear R2 and the idler gear 16 will be used for three forward gears G5, C1, O2 as well as for one reverse gear R3. Finally, for the fifth gear plane 11-5 designed as a single gear plane, the idler gear 11 will be used for three forward gears G7, O1, O2.

Thus, it follows for the 4th variant embodiment that because the lower gears 2 thru 4 and the reverse gear are placed on the first countershaft and the upper gears 5-8 are placed on the second countershaft, advantages result for the shaft and bearing dimensioning for the second countershaft.

In particular, it follows for the fourth variant embodiment that the first gear plane 7-1 designed as a single gear plane, the idler gear 7 for three forward gears G1, G2, C1 will be used. For the second gear plane 8-14 designed as a dual gear plane, the idler gear 8 for three reverse gears R1 thru R3 and the idler gear 14 for one forward gear G6 will be used. For the third gear plane 9-15 designed as a dual gear plane, the idler gear 9 will be used for three forward gears G1, G4, O1 as well as for one reverse gear R2 and the idler gear 15 will be used for three forward gears G8, C1, O2 as well as for one reverse gear R3. For the fourth gear plane 10-16 designed as a dual gear plane, the idler gear 10 will be used for three forward gears G1, G3, O1 as well as for one reverse gear R2 and the idler gear 16 will be used for three forward gears G5, C1, O2 as well as for one reverse gear R3. Finally, in the fifth gear plane 5-17 designed as a single gear plane, the idler gear 17 will be used for three forward gears G7, O1, O2.

Thus, it follows for the 5th variant embodiment that because the second gear step is placed on the second countershaft and thus only three gear wheels are placed on the first countershaft, compared to the prior gear set for the first countershaft a particular advantage regarding the shaft positioning and shaft load, particularly through one short bearing distance and a minor shaft deflection.

Thus, in particular it follows for the 5th variant embodiment that the in the first gear plane 1-13 designed as a single gear plane, the idler gear 13 will be used for three forward gears G1, G2, C1. In the second gear plane 8-14 designed as a dual gear plane, the idler gear 8 will be used for three reverse gears R1 thru R3 and the idler gear 14 will be used for one forward gear G6. In the third gear plane 9-15 designed as a dual gear plane, the idler gear 9 will be used for three forward gears G1, G4, O1 as well as for one reverse gear R2 and the idler gear 15 will be used for three forward gears G8, C1, O2 as well as for one reverse gear R3. In the fourth gear plane 10-16 designed as a dual gear plane, the idler gear 10 will be used for three forward gears G1, G3, O1 as well as for one reverse gear R2 and the idler gear 16 will be used for three forward gears G5, C1, O2 as well as for one reverse gear R3. Finally, in the fifth gear plane 5-17 designed as a single gear plane, the idler gear 17 will be used for three forward gears G7, O1, O2.

For the 6th variant embodiment an optimal adaptability of the entire gear gradation will be realized.

In particular, it follows for the 6th variant embodiment that in the first gear plane 7-1 designed as a single gear plane, the idler gear 7 will be used for one forward gear G6. In the second gear plane 2-14 designed as a single gear plane, the idler gear 14 will be used for three forward gears G1, G2, C1. For the third gear plane 9-15 designed as a dual gear plane, the idler gear 9 will be used for three forward gears G1, G4, O1 as well as for one reverse gear R2 and the idler gear 15 will be used for three forward gears G8, C1, O2 as well as for one reverse gear R3. For the fourth gear plane 10-16 designed as a dual gear plane, the idler gear 10 will be used for three forward gears G1, G3, O1 as well as for one reverse gear R2 and the idler gear 16 will be used for three forward gears G5, C1, O2 as well as for one reverse gear R3. Finally, in the fifth gear plane 11-17 the idler gear 11 will be used for three reverse gears R1 thru R3 and the idler gear 17 will be used for three forward gears G7, O1, O2.

In summary, it follows for the 7th of the 10th variant embodiments according to FIGS. 13 thru 20 that three dual gear planes and two single gear planes are provided, while for the 11th variant embodiment according to FIGS. 21 and 22 four dual gear planes and one single gear plane are provided. In addition, a first forward gear as a winding path gear results via the fifth, eighth and second gear steps. In addition thereto, an overdrive gear power-shiftable to the seventh forward gear will be realized for fuel savings.

Thus, it follows for the 7th variant embodiment that the first and the third gear step will be shifted via the first clutch and the second gear step and the reverse gear via the second clutch, a balanced load for both clutches. This represents considerable advantages or the clutch design.

In particular, it follows for the 7th variant embodiment that in the first gear plane 7-1 designed as a single gear plane, the idler gear 7 will be used for two forward gears G1, G2. In the second gear plane 8-14 designed as a dual gear plane, the idler gear 8 will be used for one forward gear G6 and the idler gear 14 will be used for three reverse gears R1 thru R3. In the third gear plane 9-15 designed as a dual gear plane, the idler gear 9 will be used for three forward gears G1, G8, O1 as well as for one reverse gear R2 and the idler gear 15 will be used for three forward gears G4, O2, O3 as well as for one reverse gear R3. In the fourth gear plane 10-16 designed as a dual gear plane, the idler gear 10 will be used for four forward gears G1, G5, O1, O3 as well as for one reverse gear R2 and the idler gear 16 will be used for three forward gears G3, O2, O3 as well as for one reverse gear R3. Finally, in the fifth gear plane 5-17 designed as a single gear plane, the idler gear 17 will be used for three forward gears G7, O1, O2.

Thus, it follows for the 8th variant embodiment that the second gear step is placed on the second countershaft and thus only three gear wheels are placed on the first countershaft, an advantage with regard to the shaft load of the first countershaft and thus an improved shaft and bearing dimensioning.

It follows in particular for the 8th variant embodiment that in the first gear plane 1-13 designed as a single gear plane, the idler gear 13 will be used for two forward gears G1, G2. In the second gear plane 2-14 designed as a single gear plane, the idler gear 14 will be used for one forward gear G6. In the third gear plane 9-15 designed as a dual gear plane, the idler gear 9 will be used for three forward gears C1, G8, O1, and the idler gear 15 will be used for two forward gears G4, O2 as well as for one reverse gear R2. In the fourth gear plane 10-16 designed as a dual gear plane, the idler gear 10 will be used for three forward gears C1, G5, O1, and the idler gear 16 will be used for two forward gears G3, O2 as well as for one reverse gear R2. Finally, in the fifth gear plane 11-17 designed as a dual gear plane, the idler gear 11 will be used for three forward gears G7, O1, O2, and the idler gear 17 ill be used for two reverse gears R1, R2.

It follows thus for the 9th variant embodiment according to FIGS. 17 and 18 that the first and third gear steps and the reverse gear step will be shifted via the first clutch, a lower load for the second clutch. Thus, the second clutch can be dimensioned smaller.

It follows thus for the 9th variant embodiment that in the first gear plane 7-1 designed as a single gear plane, the idler gear 7 will be used for two forward gears G1, G. In the second gear plane 2-14 designed as a single gear plane, the idler gear 14 will be used for one forward gear G6. In the third gear plane 9-15 designed as a dual gear plane, the idler gear 9 will be used for three forward gears G1, G8, O1 as well as one reverse gear R2 and the idler gear 15 will be used for two forward gears G4, O2 as well as for one reverse gear R3. In the fourth gear plane 10-16 designed as a dual gear plane, the idler gear 10 will be used for three forward gears G1, G5, O1 as well as for one reverse gear R2 and the idler gear 16 will be used for two forward gears G3, O2 as well as for one reverse gear R3. Finally, in the fifth gear plane 11-17 designed as a dual gear plane, the idler gear 11 will be used for three forward gears G7, O1, O2 and the idler gear 17 will be used for three reverse gears R1, R2, R3.

For the 10th variant embodiment according to FIGS. 19 and 20 it follows as a result of the placing of the sixth and seventh gears on single-gear planes to obtain a good step adaptation in particular in the upper gears.

It follows in particular for the 10th variant embodiment that in the first gear plane 7-13 designed as a dual gear plane, the idler gear 7 will be used for two forward gears G1, G2 and the idler gear 13 will be used for three reverse gears R1 thru R3. In the second gear plane 2-14 designed as a single gear plane, the idler gear 14 will be used for one forward gear G6. In the third gear plane 9-15 designed as a dual gear plane, the idler gear 9 will be used for three forward gears G1, G8, O1 as well as for one reverse gear R2 and the idler gear 15 will be used for two forward gears G4, O2 as well as for one reverse gear R3. In the fourth gear plane 10-16 designed as a dual gear plane, the idler gear 10 will be used for three forward gears G1, G5, O1 as well as for one reverse gear R2 and the idler gear 16 will be used for two forward gears G3, O2 as well as for one reverse gear R3. Finally, for the fifth gear plane 5-17 designed as a single gear plane, the idler gear 17 will be used for three forward gears G7, O1, O2.

For the 11th variant embodiment according to FIGS. 21 and 22 there are four dual gear planes and one single gear plane provided. In addition thereto, two reverse gears that are power shiftable to one another will be realized. Because of the use of an additional wheel step ZW_1 that is not used for another forward gear, other gears, in particular the lower gears, can be better adjusted.

It follows in particular for the 11th variant embodiment that in the first gear plane 7-13 designed as a dual gear plane, the idler gear 7 will be used for one forward gear G6 and the idler gear 13 will be used for one forward gear G4. In the second gear plane 2-14, the idler gear 14 will be used for three forward gears G1, G2, C1. In the third gear plane 9-15 designed as a dual gear plane, the idler gear 9 will be used for one forward gear G1 as well as for one reverse gear R2 and the idler gear 15 will be used for three forward gears G8, C1, O1. In the fourth gear plane 10-16 designed as a dual gear plane, the idler gear 10 will be used for three forward gears G1, G7, O1 as well as for one reverse gear R2 and the idler gear 16 will be used for three forward gears G5, C1, O1. Finally, in the fifth gear plane 11-17 designed as a dual gear plane, the idler gear 11 will be used for one forward gear G3 and the idler gear 17 will be used for two reverse gears R1, R2.

In summary, it follows for the 12th, 13th, 14th and 15th variant embodiments according to FIGS. 23 thru 30, that the eighth forward gear as a winding path gear is realized and two reverse gears shiftable toward one another are provided.

For the 12th variant embodiment according to FIGS. 23 and 24 there are provided four dual gear planes and one single gear plane. Thus, because the first and the third gear step as well as the reverse gear can be tied via the first clutch, the second clutch will be less loaded. Therefore, the second clutch can be dimensioned smaller.

It follows in particular for the 12th variant embodiment that in the first gear plane 8-14 designed as a dual gear plane, the idler gear 8 will be used for one forward gear G4 and the idler gear 14 will be used for one forward gear G6. In the second gear plane 9-15 designed as a dual gear plane, the idler gear 9 will be used for one forward gear G8 as well as for two reverse gears R2, R4 and the idler gear 15 will be used for one forward gear G2 as well as for two reverse gears R3, R4. In the third gear plane 10-16 designed as a dual gear plane, the idler gear 10 will be used for two forward gears G1, G8 as well as for two reverse gears R2, R3 and the idler gear 16 will be used for the reverse gears R1-R4. In the fourth gear plane 11-17 designed as a dual gear plane, the idler gear 11 will be used for one forward gear G3 and the idler gear 17 will be used for one forward gear G5. Finally, in the fifth gear plane 6-18 designed as a single gear plane, the idler gear 18 will be used for two forward gears G7, G8.

In the 13th variant embodiment according to FIGS. 25 and 26 there are provided five dual gear planes. Because the toothed gear wheels of the first, second, third and fourth gears as well as the reverse gears are placed on the shaft ends, the result is a more favorable situation with respect to the shaft deflection and the shaft bearing. Because the eighth forward gear as a winding path gear is created via additional gear stages ZW_8_1 and ZW_8_2, that are not used in another forward gear, the stepping is well adaptable, particularly in the upper gears.

It follows in particular for the 13th variant embodiment that in the first gear plane 8-14 designed as a dual gear plane, the idler gear 8 will be used for one forward gear G2 and the idler gear 14 will be used for one forward gear G4. In the second gear plane 9-15 designed as a dual gear plane, the idler gear 9 will be used for one forward gear G8 as well as for one reverse gear R2 and the idler gear 15 will be used for one forward gear G6 as well as for one reverse gear R3. In the third gear plane 10-16 designed as a dual gear plane, the idler gear 10 will be used for one forward gear G8 as well as for one reverse gear R2 and the idler gear 16 will be used for one forward gear G5 as well as for one reverse gear R3. In the fourth gear plane 11-17 designed as a dual gear plane, the idler gear 11 will be used for one forward gear G3 and the idler gear 17 will be used for two forward gears G7, G8. Finally, in the fifth gear plane 12-18 designed as a dual gear plane, the idler gear 12 will be used for one forward gear G1 and the idler gear 18 will be used for three reverse gears R1 thru R3.

For the 14th variant embodiment according to FIGS. 27 and 28, there are four dual gear plane and one single gear plane provided. Because the toothed gear wheels of the first, second and reverse gears are placed on the second countershaft, there results for the first countershaft an advantage with respect to the shaft bearing and shaft load.

It follows in particular for the 14th variant embodiment that in the first gear plane 8-14 designed as a dual gear plane, the idler gear 8 will be used for one forward gear G6 and the idler gear 14 will be used for one forward gear G4. In the second gear plane 9-15 the idler gear 9 will be used for one forward gear G8 as well as for one reverse gear R2 and the idler gear 15 will be used for one forward gear G2 as well as for one reverse gear R3. In the third gear plane 10-16 designed as a dual gear plane, the idler gear 10 will be used for two forward gears G3, G8 as well as for one reverse gear R2 and the idler gear 16 will be used for three reverse gears R1, R2. In the fourth gear plane 11-17 designed as a dual gear plane, the idler gear 11 will be used for two forward gears G7, G8 and the idler gear 17 will be used for one forward gear G5. Finally, in the fifth gear plane 6-18 designed as a single gear plane, the idler gear 18 will be used for one forward gear G1 as well as for one reverse gear R3.

For the 15th variant embodiment according to FIGS. 29 and 30 there are provided four dual gear planes and one single gear plane. Because of the placement of the gear set there results a particularly good stepping adaptation.

It follows in particular for the 15th variant embodiment that in the first gear plane 8-14 designed as a dual gear plane, the idler gear 8 will be used for one forward gear G6 and the idler gear 14 will be used for one forward gear G4. In the second gear plane 9-15 designed as a dual gear plane, the idler gear 9 will be used for two forward gears G2, G8 as well as for two reverse gears R2, R4 and the idler gear 15 will be used for four reverse gears R1 thru R4. In the third gear plane 10-16 designed as a dual gear plane, the idler gear 10 will be used for one forward gear G8 as well as for two reverse gears R2, R3 and the idler gear 16 will be used for one forward gear G1 as well as for two reverse gears R3, R4. In the fourth gear plane 11-17 designed as a dual gear plane, the idler gear 11 will be used for one forward gear G5 and the idler gear 17 will be used for one forward gear G3. Finally, in the fifth gear plane 12-6 designed as a single gear plane, the idler gear 12 will be used for two forward gears G7, G8.

It is possible, that in one or even more variant embodiments, at least one additional gear stage ZW_x, e.g., ZW_8 or even ZW_8_1 and ZW_8_2 will be used as winding path gears, which will not be used in a direct forward gear. The use of an additional gear stage will follow from the respective figures of the variant embodiments.

Gear wheels x1, x2, . . . x7, x8 can also be used for additional winding path gears, that may be added as supplement to a gear plane while the numbering of the gear wheels x1, x2, . . . x7, x8 will be performed as follows. The numbering starts with the first gear wheel x1 of the first countershaft w_v1 starting with the allocated output stage i_ab_1 consecutively through to the fourth gear wheel x4, while the first gear wheel will be designated on the second countershaft w_v2 starting with the allocated output stage i_ab_2 with x5 and the additional gear wheels will be designated consecutively up to x8. If the additional gear wheel x1, x2, . . . x7, x8 will be used within the framework of a reverse gear ratio, a drive reversal will be used will occur, for example, via the use of an intermediate wheel ZR on an intermediate shaft w_zw or the like.

For all variant embodiments of the double clutch transmissions, as a result of this multi use of individual idler wheels, fewer gear planes are required and thus fewer components are required for the same number of gears, which results in an advantageous savings of construction space and cost.

Independent of the respective variant embodiment, the number “1” in a field of the respective table of the shift pattern according to FIGS. 2, 4, 6, 8, 10, 12, 14, 16, 18, 20, 22, 24, 26, 28 and 30, indicates that the allocated clutch K1, K2, or the allocated coupling device A, B, C, D, E, F, G, H, I, J, K, L or the allocated shift element M, N respectively is engaged or activated. On the other hand, a free field in the respective table of the shift pattern according to FIGS. 2, 4, 6, 8, 10, 12, 14, 16, 18, 20, 22, 24, 26, 28 and 30, indicates that the allocated clutch K1, K2, or the allocated coupling device A, B, C, D, E, F, G, H, I, J, K, L or the allocated shift element M, N respectively is disengaged.

With regard to the coupling device S_ab1 or S_ab2 allocated to an output gear wheel 20 or 21, differing from the above mentioned rule that with a blank field in the respective table of the shift patterns according to FIGS. 2, 4, 6, 8, 10, 12, 14, 16, 18, 20, 22, 24, 26, 28 and 30, the coupling device S_ab1 or S_ab2 must be disengaged, and that for a field with the number “1” in the respective table of the shift pattern according to FIGS. 2, 4, 6, 8, 10, 12, 14, 16, 18, 20, 22, 24, 26, 28 and 30, the coupling device S_ab1 or S_ab2 should be engaged. Independent of the gear, the connecting element S_ab1 or S_ab2 must even be engaged for a group of gears of fields with the number “1”, whereas the coupling element S_ab1 or S_ab2 can be disengaged as well as or engaged for another group of gears with a field with the number “1”.

Moreover, in many instances there is the possibility to insert additional coupling or shift elements without having an effect on the power flow. Thus, an advanced gear selection can be made possible.

### REFERENCE MARKS

1 fixed gear of the second transmission input shaft
2 fixed gear of the of the second transmission input shaft
3 fixed gear of the second transmission input shaft
4 fixed gear of the first transmission input shaft
5 fixed gear of the first transmission input shaft
6 fixed gear of the first transmission input shaft
7 idler gear of the first countershaft
8 idler gear of the first countershaft
9 idler gear of the first countershaft
10 idler gear of the first countershaft
11 idler gear of the first countershaft
12 idler gear of the first countershaft or the second countershaft
13 idler gear of the second countershaft
14 idler gear of the second countershaft
15 idler gear of the second countershaft
16 idler gear of the second countershaft
17 idler gear of the second countershaft
18 idler gear of the second countershaft
19 fixed gear of the output shaft
20 output gear wheel of the first countershaft
21 output gear wheel of the second countershaft
22 torsion vibration damper
K1 first clutch
K2 second clutch
w_an input shaft
w_ab output shaft
w_v1 first countershaft
w_v2 second countershaft
w_k1 first transmission input shaft
w_k2 second transmission input shaft
A coupling device
B coupling device
C coupling device
D coupling device
E coupling device
F coupling device
G coupling device
H coupling device
I coupling device
K coupling device
L coupling device
i_1 gear stage first forward gear
i_2 gear stage second forward gear
i_3 gear stage third forward gear
i_4 gear stage fourth forward gear
i_5 gear stage fifth forward gear
i_6 gear stage sixth forward gear
i_7 gear stage seventh forward gear
i_8 gear stage eighth forward gear
i_R gear stage reverse gear
ZW_1 additional gear step for winding path gears
ZW_8 additional gear step for winding path gears
ZW_8_1 additional gear step for winding path gears
ZW_8_2 additional gear step for winding path gears
i_ab1 output stage on the first countershaft
i_ab_2output stage on the second countershaft
G1 first forward gear
G2 second forward gear
G3 third forward gear
G4 fourth forward gear
G5 fifth forward gear
G6 sixth forward gear
G7 seventh forward gear
G8 eighth forward gear
C1 crawler gear (crawler)
C2 crawler gear (crawler)
01 overdrive gear (overdrive)
02 overdrive gear (overdrive)
03 overdrive gear (overdrive)
04 overdrive gear (overdrive)
R1 reverse gear
R2 reverse gear
R3 reverse gear
R4 reverse gear
R5 reverse gear
w_zw intermediate shaft
ZR intermediate gear for drive reversal
ZS used gear stage
M shift element
N shift element optional
S_ab1 coupling device on the output stage optional
S_ab2 coupling device on the output stage optional
Isb. power shiftable

1-6. (canceled)

7. A double clutch transmission comprising:
first and second clutches (K1, K2) each comprising an input side connected to a drive shaft (w_an) and an output side connected to a respective one of a first and a second transmission input shaft (w_k1, w_k2) coaxially arranged with respect to one another;
at least first and second countershafts (w_v1, w_v2) supporting toothed idler gearwheels (7, 8, 9, 10, 11, 12, 13, 14, 15, 16, 17, 18);
toothed fixed gearwheels (1, 2, 3, 4, 5, 6) being supported on the first and the second transmission input shafts (w_k1, w_k2) in a rotationally fixed manner, the fixed gearwheels (1, 2, 3, 4, 5, 6) engaging with at least one of the idler gearwheels (7, 8, 9, 10, 11, 12, 13, 14, 15, 16, 17, 18);
a plurality of coupling devices (A, B, C, D, E, F, G, H, I, J, K, L) for connecting an idler gearwheel (7, 8, 9, 10, 11, 12, 13, 14, 15, 16, 18) to one of the first and the second countershafts (w_v1, w_v2) in a rotationally fixed manner;
a first output gear (20) being provided on the first countershaft (w_v1) and a second output gear (21) being provided on the second countershaft (w_v2), and each of the first and the second output gears (20, 21); and
at least one shift element (M) for rotationally fixedly connecting two gearwheels with one another so that at least several power-shiftable forward gears (1, 2, 3, 4, 5, 6, 7, 8) and at least one reverse gear (R1, R2, R3, R4) are shiftable;
wherein five gear planes (7-1, 7-13, 8-12, 8-14, 9-2, 9-15, 1-13, 3-13, 2-14, 10-14, 1-15, 9-15, 10-16, 11-5, 5-17, 11-17, 6-18, 12-6, 12-18) are provided, at least three of the five gear planes are dual gear planes (7-13, 8-12, 8-14, 10-14, 9-15, 10-16, 11-15, 11-17, 12-18), an idler gearwheel (7, 8, 9, 10, 11, 12, 13, 14, 15, 16, 17, 18) of the first and the second countershafts (w_v1, w_v2) and a fixed gearwheel (1, 2, 3, 4, 5, 6) of one of the transmission input shafts (w_k1, w_k2) is allocated for each dual gear plane (7-13, 8-12, 8-14, 10-14, 9-15, 10-16, 11-15, 11-17, 12-18), while for at least one of the dual gear planes (7-13, 8-12, 8-14, 10-14, 9-15, 10-16, 11-15, 11-17, 12-18) at least one idler gearwheel (7, 8, 9, 10, 11, 12, 13, 14, 15, 16, 17, 18) can be used for at least two gears so that at least one power-shiftable winding path gear is shiftable via the at least one shift element (M).

8. The double clutch transmission according to claim 7, wherein the at least one shift element (M) is located on the first countershaft (w_v1) and, upon activation of the at least one shift element (M) on the first countershaft (w_v1), a first idler gearwheel (9) of a first subtransmission can be connected with a second idler gearwheel (10) of the first subtransmission so that, via activation of the at least one shift element (M), at least one of a first forward gear (G1) and an eighth forward gear (G8) is shiftable as a winding path gear.

9. The double clutch transmission according to claim 7, wherein the double clutch transmission has three dual gear planes and two single gear planes, the fixed gears (1, 2, 3) of the second transmission input shaft (w_k2) of a second subtransmission are allocated to one first gear plane (1-13, 7-1, 8-1; 8-12, 7-13), which is one of a single gear plane and a dual gear plane, a second gear plane (9-2, 2-14; 8-14), which is one of a single gear plane and a dual gear plane, and a third gear plane (3-13; 9-15), which is one of a single gear plane and a dual gear plane, and while the fixed gears (4, 5) of the first transmission input shaft (w_k1) of a first subtransmission are allocated to a fourth gear plane (10-14, 10-16), which is a dual gear plane, and a fifth gear plane (5-17, 11-5; 11-15, 11-17), which is one of a single gear plane and a dual gear plane.

10. The double clutch transmission according to claim 7, wherein the double clutch transmission has four dual gear planes and a single gear plane, the fixed gears (2, 3) of the second transmission input shaft (w_k2) of a second subtransmission are allocated to a first gear plane (8-14), which is a dual gear plane, and a second gear plane (9-15), which is a dual gear plane, and the fixed gears (4, 5, 6) of the first transmission input shaft (w_k1) of a first subtransmission are allocated to a one third gear plane (10-16), which is a dual gear plane, a fourth gear plane (11-17), which is a dual gear plane, and one fifth gear plane (6-18, 12-6), which is a single gear plane.

11. The double clutch transmission according to claim 7, wherein the double clutch transmission has four dual gear planes and a single gear plane, the fixed gears (1, 2, 3) of the second transmission input shaft (w_k2) of a second subtransmission are allocated to a first gear plane (7-13), which is a dual gear plane, a second gear plane (2-14), which is a single gear plane and a third gear plane (9-15), which is a dual gear plane, and the fixed gears (4, 5) of the first transmission input shaft (w_k1) of a first subtransmission are allocated to a fourth gear plane (10-16), which is a dual gear plane, and a fifth gear plane (11-17), which is a dual gear plane.

12. The double clutch transmission according to claim 7, wherein the double clutch transmission has five dual gear planes, the fixed gears (2, 3) of the second transmission input shaft (w_k2) of a second subtransmission are allocated to a first gear plane (8-14) and a second gear plane (9-15) which are each dual gear planes, and the fixed gears (4, 5, 6) of the first transmission input shaft (w_k1) of a first subtransmission are allocated to a third gear plane (10-16), a fourth gear plane (11-17) and a fifth gear plane (12-18) which are each dual gear planes.
